(19) United States
(12) Patent Application Publication
(10) Pub. No.: US 2026/0124851 A1
(43) Pub. Date: May 7, 2026

(54) MULTIMODAL ENVELOPE SEALER

(71) Applicant: Pregis LLC, Chicago, IL (US)

(72) Inventor: Argenis Almodovar, Chicago, IL (US)

(21) Appl. No.: 19/375,109

(22) Filed: Oct. 30, 2025

Related U.S. Application Data
(60) Provisional application No. 63/715,514, filed on Nov. 1, 2024.

(51) Int. Cl. B43M 5/04

(52) U.S. Cl. CPC B43M 5/045

(57) ABSTRACT

Envelope sealing machines include a sealer that can operate in different sealing modes in which the values of the sealing parameters are tailored to the specific material configuration of the envelope being sealed. For example, a first sealing mode can be used to apply sealing conditions appropriate for paper envelopes, and a second sealing mode can be used to apply sealing conditions appropriate for plastic film. A controller can receive inputs identifying the material configuration of the envelope to be sealed, select the appropriate values for the sealing parameters for that material configuration, and provide inputs to the sealer that cause the sealer to apply the sealing conditions appropriate for the material configuration.

### CROSS-REFERENCE TO RELATED APPLICATIONS

This application claims the benefit under 35 U.S.C. §119(e) of U.S. Application No. 63/715,514, filed November 1, 2024, the contents of which are incorporated by reference herein in their entirety.

### BACKGROUND

Automated bagging machines typically are configured to seal envelopes made of a single type of material, such as paper or plastic. Plastics such as polyethylene have been used widely in the manufacture of envelopes for decades. The use of paper envelopes, however, is becoming common due to paper’s environmentally friendly characteristics, such as recyclability. Accordingly, a bagging machine with the ability to seal both paper and plastic envelopes could provide a shipper with greater flexibility in tailoring the packaging for a particular item with the optimum type of packaging for that item.

Automated bagging machines typically apply sealing conditions to the loaded envelope to form a closure seal that maintains the envelope in a closed state so that the packaged item is retained within the envelope during shipping. In applications where a heat-activatable material is used to form the closure seal, the sealing parameters usually include sealing temperature, sealing pressure, and dwell time, i.e., the length of time over which the sealing conditions are applied.

The optimal sealing parameters for paper and plastic differ. These differences arise from differences in the material composition, material geometry, and manner of sealing of paper and plastic. For example, in the case of plastic envelopes, the envelope walls are heated and pressed together so that the walls weld together to form the closure seal. In the case of paper envelopes, by contrast, the walls and the heat-activatable material are heated and pressed together so that heat-activatable material, upon cooling, fixes the walls to each other.

The differences between the optimal sealing parameters for paper and plastic present challenges in configuring an automated bagging machine to process both paper and plastic envelopes in a seamless manner that allows changes between paper and plastic envelopes without slowing down the bagging process. For example, the optimal sealing pressure for plastic envelopes can be substantially lower than that of paper envelopes when using the same dwell time. This difference can arise, for example, due to the higher thermal conductivity of plastic in relation to paper, the thicker walls of a typical paper envelope, the need to heat the heat-activatable material in the paper envelope, etc. The need to adjust operational parameters such as sealing pressure when transitioning between paper and plastic envelopes can reduce the maximum available throughput of the bagging machine when such adjustments are needed.

### SUMMARY

In one aspect of the disclosed technology, an envelope sealing machine includes a controller including a processor. The controller is configured to obtain ranges of at least two variable sealing parameters corresponding to a material configuration of a first envelope. The at least two variable sealing parameters include a sealing pressure, a sealing temperature, and/or a dwell time over which the sealing pressure and the sealing temperature are applied to the first envelope. The controller also is configured to select values for each of the at least two variable sealing parameters within their respective ranges.

The envelope sealing machine also includes a sealer communicatively coupled to the controller. The sealer also includes two opposing surfaces configured to apply the sealing pressure to a closure area on first and second walls of the first envelope, and a heat source configured to heat the closure area to apply the sealing temperature to the closure area.

The sealing pressure, the sealing temperature, and the dwell time in accordance with the selected values of the at least two variable sealing parameters produce sealing conditions sufficient to form a closure seal between the first and second walls of the first envelope in the closure area.

In another aspect of the disclosed technology, the sealing conditions are sufficient to form the closure seal with sufficient strength to retain an item within an envelope pocket defined by the first and second walls of the first envelope.

In another aspect of the disclosed technology, the controller is configured to obtain ranges of at least two variable sealing parameters corresponding to a material configuration of a second envelope, the at least two variable sealing parameters corresponding to the material configuration of the second envelope including a sealing pressure, a sealing temperature, and/or a dwell time over which the sealing pressure and the sealing temperature are applied to the second envelope, and select values for each of the at least two variable sealing parameters corresponding to the material configuration of a second envelope within their respective ranges.

The opposing surfaces of the sealer are configured to apply the sealing pressure to a closure area on first and second walls of the second envelope, and the heat source is configured to heat the closure area of the second envelope to apply the sealing temperature to the closure area of the second envelope. The sealing pressure, the sealing temperature, and the dwell time in accordance with the selected values of the at least two variable sealing parameters for the second envelope produce sealing conditions sufficient to form a closure seal between the first and second walls of the second envelope in the closure area of the second envelope.

In another aspect of the disclosed technology, the at least two variable sealing parameters corresponding to the material configurations of the first and second envelopes include the sealing temperature and the dwell time, and the sealing pressures corresponding to the material configurations of the first and second envelopes are non-variable.

In another aspect of the disclosed technology, the sealing pressure corresponding to the material configuration of the first envelope is about equal to the sealing pressure corresponding to the material configuration of the second envelope.

In another aspect of the disclosed technology, the sealing temperature corresponding to the material configuration of the first envelope is different than the sealing temperature corresponding to the material configuration of the second envelope, and/or the dwell time corresponding to the material configuration of the first envelope is different than the dwell time corresponding to the material configuration of the second envelope.

In another aspect of the disclosed technology, the sealing pressure corresponding to the material configuration of the first envelope and the sealing pressure corresponding to the material configuration of the second envelope are less than or equal to about 200 psi.

In another aspect of the disclosed technology, the sealing pressure corresponding to the material configuration of the first envelope and the sealing pressure corresponding to the material configuration of the second envelope are less than or equal to about 100 psi.

In another aspect of the disclosed technology, the sealing pressure corresponding to the material configuration of the first envelope and the sealing pressure corresponding to the material configuration of the second envelope are between about 45 psi and about 60 psi.

In another aspect of the disclosed technology, the dwell time corresponding to the material configuration of the first envelope is within a range of about 0.3 second to about 1.5 seconds, and the sealing temperature corresponding to the material configuration of the first envelope is within a range of about 300°F to about 380°F.

In another aspect of the disclosed technology, the dwell time corresponding to the material configuration of the second envelope is within a range of about 0.2 second to about 0.3 second, and the sealing temperature corresponding to the material configuration of the second envelope is within a range of about 250°F to about 290°F.

In another aspect of the disclosed technology, the controller is communicatively coupled to a memory storing the ranges of the at least two variable sealing parameters corresponding to the material configuration of the first envelope. The controller is configured to obtain the ranges of the at least two variable sealing parameters corresponding to the material configuration of the first envelope by identifying the material configuration of the first envelope, and retrieving, from the memory, the ranges of the at least two variable sealing parameters corresponding to the material configuration of the first envelope.

In another aspect of the disclosed technology, the envelope sealing machine further includes the memory.

In another aspect of the disclosed technology, the envelope sealing machine further includes a user interface communicatively coupled to the controller and configured to receive a user input indicating a selection of the material configuration of the first envelope. The controller is configured to identify the material configuration of the first envelope based on the user input.

In another aspect of the disclosed technology, the envelope sealing machine further includes an input device communicatively coupled to the controller and configured to obtain, from the first envelope, the material configuration of the first envelope by reading printed information on the first envelope. The controller is configured to identify the material configuration of the first envelope based on the printed information on the first envelope as read by the input device.

In another aspect of the disclosed technology, the envelope sealing machine further includes an input device communicatively coupled to the controller and configured to obtain, from the first envelope, the ranges of the at least two variable sealing parameters by reading printed information on the first envelope. The controller is configured to obtain the ranges of the at least two variable sealing parameters based on the printed information on the first envelope as read by the input device.

In another aspect of the disclosed technology, the material configuration of the first envelope includes a type of material forming the first envelope, a type of heat-activatable material present on at least one of the first and second walls of the first envelope in the closure area, and/or an amount of the heat-activatable material.

In another aspect of the disclosed technology, an envelope sealing system includes the envelope sealing machine, a first envelope, and a second envelope. The material type of the first envelope is paper; and the material type of the second envelope is plastic.

In another aspect of the disclosed technology, the dwell time corresponding to the material configuration of the first envelope is within a range of about 0.3 second to about 1.5 seconds, the sealing temperature corresponding to the material configuration of the first envelope is within a range of about 300°F to about 380°F, the dwell time corresponding to the material configuration of the second envelope is within a range of about 0.2 second to about 0.3 second, and the sealing temperature corresponding to the material configuration of the second envelope is within a range of about 250°F to about 290°F.

In another aspect of the disclosed technology, the first and second walls of the second envelope include a heat sealable film.

In another aspect of the disclosed technology, the first and second walls of the first envelope include kraft paper.

In another aspect of the disclosed technology, the kraft paper has a weight within the range of about 90 grams per square meter to about 130 grams per square meter.

In another aspect of the disclosed technology, the first envelope further includes a heat-activatable material located on at least one of the first and second walls of the first envelope in the closure area of the first envelope, the heat-activatable material configured to form the closure seal of the first envelope when subjected to the sealing conditions for the first envelope.

In another aspect of the disclosed technology, the heat-activable material is one of a hot-melt adhesive and a heat-sealable material.

In another aspect of the disclosed technology, an amount of the heat-activatable material on the first envelope is within the range of about 5 lb/ream to about 7 lb/ream.

In another aspect of the disclosed technology, the sealing conditions are sufficient to form the closure seal of the first envelope and/or the second envelope with a peel strength and/or a hot tack strength selected within the range between about 1 pound per linear inch to about 4 pounds per linear inch.

In another aspect of the disclosed technology, the envelope sealing system further includes a first web including a plurality of the first envelopes separated from each other by regions of weakness extending transverse to a longitudinal direction of the first web, and a second web including a plurality of the second envelopes separated from each other by regions of weakness extending transverse to a longitudinal direction of the second web. The envelope sealing machine further includes a web advancer configured to advance the first and second webs in relation to the sealer in the respective longitudinal directions of the first and second webs to align the respective closure areas on the first and second envelopes with the sealer.

In another aspect of the disclosed technology, an envelope sealing machine includes a controller including a processor, and a sealer communicatively coupled to the controller. The sealer includes two opposing surfaces configured to, in response to inputs provided by the controller, apply a sealing pressure to a closure area on first and second walls of an envelope over a dwell time. The sealer also includes a heat source configured to, in response to the inputs provided by the controller, heat the closure area to apply a sealing temperature to the closure area over the dwell time.

The controller is configured to select and provide as the inputs to the sealer a first set of values for the sealing pressure, sealing temperature, and dwell time corresponding to a first material configuration of the envelope. The sealing pressure, sealing temperature, and dwell time, when applied by the sealer to the closure area in accordance with the first set of values and with the envelope in the first material configuration, produce sealing conditions sufficient to form a closure seal between the first and second walls of the envelope in the closure area.

The controller is configured to select and provide as the inputs to the sealer a second set of values for the sealing pressure, sealing temperature, and dwell time corresponding to a second material configuration of the envelope. The sealing pressure, sealing temperature, and dwell time, when received by the sealer and applied by the sealer to the closure area of the envelope in accordance with the second set of values and with the envelope in the second material configuration, producing sealing conditions sufficient to form the closure seal between the first and second walls of the envelope in the closure area.

In another aspect of the disclosed technology, the sealing conditions are sufficient to form the closure seal with sufficient strength to retain an item within an envelope pocket defined by the first and second walls of the envelope.

In another aspect of the disclosed technology, the sealer is configured to operate in a first sealing mode in which the sealer applies the sealing pressure, sealing temperature, and dwell time to the closure area of the envelope in accordance with the first set of values for the sealing pressure, sealing temperature, and dwell time, and the sealer is configured to operate in a second sealing mode in which the sealer applies the sealing pressure, sealing temperature, and dwell time to the closure area of the envelope in accordance with the second set of values for the sealing pressure, sealing temperature, and dwell time.

In another aspect of the disclosed technology, the controller is configured to receive an input indicating the material configuration of the envelope, and to select the sealing mode of the sealer in response to the input.

In another aspect of the disclosed technology, the input indicating the material configuration of the envelope is a user input, and the envelope sealing machine further includes a user interface communicatively coupled to the controller and configured to receive the user input.

In another aspect of the disclosed technology, the envelope sealing machine further includes an input device communicatively coupled to the controller and configured to obtain, from the envelope, the input indicating the material configuration of the envelope by reading printed information on the first envelope indicating the material configuration of the envelope.

In another aspect of the disclosed technology, the controller is communicatively coupled to a memory storing the sealing pressure, sealing temperature, and dwell time corresponding to the first and second material configurations of the envelope. The controller is configured to select the values of the sealing pressure, sealing temperature, and dwell time to be applied by the sealer to the closure area of the envelope by identifying the material configuration of the envelope based on the input indicating the material configuration of the envelope, and retrieving, from the memory, the values of the sealing pressure, sealing temperature, and dwell time corresponding to the material configuration of the envelope.

In another aspect of the disclosed technology, the envelope sealing machine further includes the memory.

In another aspect of the disclosed technology, the first material configuration of the envelope is paper; and the second material configuration of the envelope is plastic.

In another aspect of the disclosed technology, the sealing pressure corresponding to the first material configuration of the envelope is about equal to the sealing pressure corresponding to the second material configuration of the envelope.

In another aspect of the disclosed technology, the sealing temperature corresponding to the first material configuration of the envelope is different than the sealing temperature corresponding to the second material configuration of the envelope, and/or the dwell time corresponding to the first material configuration of the envelope is different than the dwell time corresponding to the second material configuration of the envelope.

In another aspect of the disclosed technology, the sealing pressure corresponding to the first material configuration of the envelope and the sealing pressure corresponding to the second material configuration of the envelope are less than or equal to about 200 psi.

In another aspect of the disclosed technology, the sealing pressure corresponding to the first material configuration of the envelope and the sealing pressure corresponding to the second material configuration of the envelope are less than or equal to about 100 psi.

In another aspect of the disclosed technology, the sealing pressure corresponding to the first material configuration of the envelope and the sealing pressure corresponding to the second material configuration of the envelope are between about 45 psi and about 60 psi.

In another aspect of the disclosed technology, the dwell time corresponding to the first material configuration of the envelope is within a range of about 0.3 second to about 1.5 seconds, and the sealing temperature corresponding to the first material configuration of the envelope is within a range of about 300°F to about 380°F.

In another aspect of the disclosed technology, the dwell time corresponding to the second material configuration of the envelope is within a range of about 0.2 second to about 0.3 second, and the sealing temperature corresponding to the second material configuration of the envelope is within a range of about 250°F to about 290°F.

In another aspect of the disclosed technology, a method for sealing an envelope includes receiving a first envelope having a first material configuration, receiving a second envelope having a second material configuration, and providing an envelope sealing machine. The envelope sealing machine includes a controller having a processor, and a sealer communicatively coupled to the controller. The sealer includes two opposing surfaces configured to, in response to inputs provided by the controller, apply a sealing pressure to a closure area on first and second walls of the first envelope or the second envelope over a dwell time. The sealer also includes a heat source configured to, in response to the inputs provided by the controller, heat the closure area on the first and second walls of the first envelope or the second envelope to apply a sealing temperature to the closure area on the first and second walls of the first envelope or the second envelope over the dwell time.

The method further includes operating the sealer in a first sealing mode in which the sealer applies the sealing pressure, sealing temperature, and dwell time to the closure area of the first envelope in accordance with a first set of values for the sealing pressure, sealing temperature, and dwell time received by the sealer as the inputs from the controller, to form a closure seal between the first and second walls of the first envelope in the closure area of this first envelope.

The method further includes operating the sealer in a second sealing mode in which the sealer applies the sealing pressure, sealing temperature, and dwell time to the closure area of the second envelope in accordance with a second set of values for the sealing pressure, sealing temperature, and dwell time received by the sealer as the inputs from the controller, to form a closure seal between the first and second walls of the second envelope in the closure area of the second envelope.

In another aspect of the disclosed technology, the controller is configured to select the first set of values for the sealing pressure, sealing temperature, and dwell time to form the closure seal between the first and second walls of the first envelope with sufficient strength to retain an item within an envelope pocket defined by the first and second walls of the first envelope.

The controller is configured to select the second set of values for the sealing pressure, sealing temperature, and dwell time to form the closure seal between the first and second walls of the second envelope with sufficient strength to retain the item within an envelope pocket defined by the first and second walls of the second envelope.

In another aspect of the disclosed technology, the controller is configured to receive an input indicating the first and second material configurations of the first and second envelopes, and to select the sealing mode of the sealer in response to the input.

In another aspect of the disclosed technology, the controller is communicatively coupled to a memory storing the sealing pressure, sealing temperature, and dwell time corresponding to the first and second material configurations of the envelope.

The method further includes selecting the values of the sealing pressure, sealing temperature, and dwell time to be applied by the sealer to the closure area of the envelope by using the controller to identify the material configuration of the envelope based on the input indicating the material configuration of the envelope, and retrieving, from the memory, the values of the sealing pressure, sealing temperature, and dwell time corresponding to the material configuration of the envelope.

In another aspect of the disclosed technology, the first material configuration is paper, and the second material configuration is plastic.

In another aspect of the disclosed technology, the sealing pressure in the first set of values is about equal to the sealing pressure in the second set of values.

In another aspect of the disclosed technology, the sealing temperature in the first set of values is different than the sealing temperature in the second set of values, and/or the dwell time corresponding in the first set of values is different than the dwell time in the second set of values.

In another aspect of the disclosed technology, the sealing pressure in the first set of values and sealing pressure in the second set of values are less than or equal to about 200 psi.

In another aspect of the disclosed technology, the sealing pressure in the first set of values and the sealing pressure in the second set of values are less than or equal to about 100 psi.

In another aspect of the disclosed technology, the sealing pressure in the first set of values and the sealing pressure in the second set of values are between about 45 psi and about 60 psi.

In another aspect of the disclosed technology, the dwell time in the first set of values is within a range of about 0.3 second to about 1.5 seconds, and the sealing temperature in the first set of values is within a range of about 300°F to about 380°F.

In another aspect of the disclosed technology, the dwell time in the second set of values is within a range of about 0.2 second to about 0.3 second, and the sealing temperature in the second set of values is within a range of about 250°F to about 290°F.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 is a top-front perspective view of a bagging machine, depicting the bagging machine during an operational cycle of the bagging machine;

FIGS. 2-7 are partial, enlarged top-front perspective views of the bagging machine of FIG. 1, depicting sequential operational cycles of the machine following the operation cycle shown in FIG. 1.

FIG. 8 is a cross-sectional view of a sealer and a wall handling device of the bagging machine shown in FIGS. 1-7, taken through the line VIII-VIII of FIG. 6, depicting an envelope after having an opening formed therein and about to be loaded and sealed on the bagging machine;

FIG. 9 is a cross-sectional view of the bagging machine shown in FIGS. 1-8, taken through the line IX-IX of FIG. 4, depicting the envelope after having an opening formed therein and about to be loaded and sealed on the bagging machine;

FIG. 10 is a top-front perspective view of a breaking element and seal flattener assembly of the bagging machine shown in FIGS. 1-0, depicting a breaking element and a seal flattener of the assembly in their respective upper positions;

FIG. 11 is a front perspective view of the breaking element and seal flattener assembly shown in FIG. 10, depicting the breaking element in its lower position and depicting the seal flattener in its upper position;

FIG. 12 is a diagrammatic view of various electrical and electronic components of the bagging machine shown in FIGS. 1-12;

FIG. 13 is a perspective view of a web of envelopes for use in the bagging machine shown in FIGS. 1-11;

FIG. 14 is a magnified view of an alternative embodiment of the web shown in FIG. 13;

FIG. 15 is a top-rear perspective view of an alternative embodiment of a breaking element of the bagging machine shown in FIGS. 1-12;

FIG. 16 is a top-front perspective view of an alternative embodiment of the bagging machine shown in FIGS. 1-12, depicting a breaking element of the bagging machine in a lower position;

FIG. 17 is a front view of a carrier assembly of the bagging machine shown in FIG. 16, depicting, the breaking element in the upper position;

FIG. 18 is a schematic illustration of a multimodal envelope sealer of the bagging machine shown in FIGS. 1-12;

FIG. 19 is a flow diagram illustrating an embodiment of a method of sealing an envelope using the multimodal envelope sealer of FIG. 18;

FIG. 20 is a flow diagram illustrating another embodiment of a method of sealing an envelope using the multimodal envelope sealer of FIG. 18; and

FIG. 21 is a contour plot illustrating measured peel strength of a closure seal formed in a paper envelope using the multimodal envelope sealer of FIG. 18 as a function of dwell time and sealing temperature for a fixed sealing pressure.

### DETAILED DESCRIPTION

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

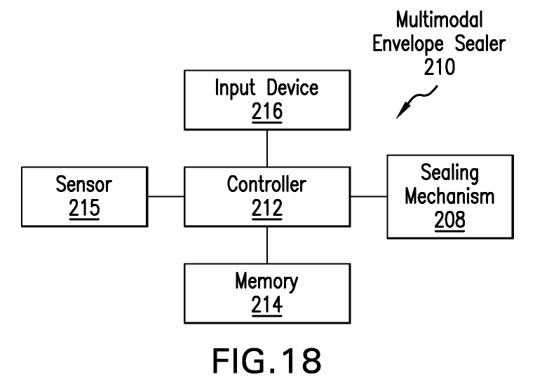

A bagging machine 200 for loading and sealing envelopes 120 is provided. The bagging machine 200 includes a multimodal envelope sealer 210 illustrated schematically in FIG. 18. The multimodal envelope sealer 210 includes a sealer 208, a controller 212, a memory 214, and an input device 216. The sealer 208, memory 214, sensor 215, and input device 216 are communicatively coupled to the controller 212.

The multimodal sealer 210 is described in connection with the bagging machine 200 for illustrative purposes only. The multimodal sealer 210 can be incorporated into bagging machines having other configurations.

The sealer 208, using inputs from the controller 212, can apply sealing parameters that are suitable for sealing both paper and plastic envelopes. Sealing parameters have been identified that achieve a target seal strength within desired dwell times, while employing significantly lower sealing pressures than those usually applied to paper envelopes. The use of these sealing parameters can eliminate the need to adjust the sealing pressure when transitioning between paper and plastic envelopes.

The sealer 208 can operate in different sealing modes in which the values of the sealing parameters are tailored to the specific material configuration of the envelope 120 being sealed. For example, a first sealing mode can be used to apply sealing conditions appropriate for paper envelopes, and a second sealing mode can be used to apply sealing conditions appropriate for plastic film. The controller 212 can receive inputs identifying the material configuration of the envelope 120 to be sealed, select the appropriate sealing mode based on the material configuration, select appropriate values for the sealing parameters based on the selected operating mode, and provide inputs to the sealer 208 that cause the sealer 208 to apply the sealing conditions appropriate for the selected operating mode.

Packaging containers can include parcel packaging and other containers to package items. Packaging containers are configured to contain and hold an item, typically enclosing the item, during shipping or storage of the item. Parcel packaging is configured for shipping and/or storing products, such as for storage in warehouse or retail shelves and displays. Examples of parcel packaging include flexible shipping containers such as envelopes, which can have varying degrees of flexibility and typically are used to ship or mail small or relatively flat items or smaller items around which the walls of the envelope can conform. Flexible shipping containers such as envelopes can be padded or non-padded, can be made of materials such as paper and flexible cardboard, can be configured with or without sidewalls or gussets, and can include larger envelopes such as mailers. Examples of parcel packaging also include bags, such as paper or poly bags, which can have a self-sealing capability and are typically used to ship small to medium-sized items; boxes, which can be formed from paperboard, cardboard, wood, or plastic, and typically have a rigid or semi-rigid structure suitable for holding medium to large-size items and heavier items; and shipping tubes or tube mailers, typically used to ship documents and paper items.

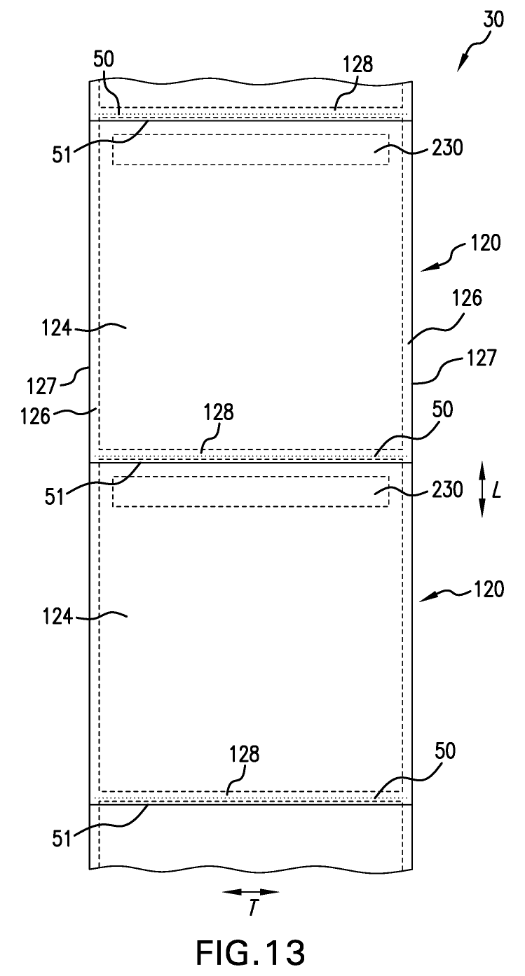

Referring to FIG. 13, the envelopes 120 are configured to contain and hold an item to be packaged, typically enclosing the item, while the item is being mailed or shipped, or otherwise needs to be packaged in a closed container. The following details of the envelope 120 are provided for illustrative purposes only. The bagging machine 200 can be used to seal envelopes having other configurations, including envelopes having a foldable flap that covers an opening 140 to an interior pocket, or envelope pocket 125, of the envelope 120 after the item has been inserted into the envelope; and envelopes having double-ply walls with, or without padding, insulating, and/or expandable material disposed between the plies of the walls.

The envelope 120 includes an envelope body having a wall 122 and an opposing wall 124, as shown in FIG. 13. The walls 122, 124 are formed from regular kraft paper, and define an internal containment area, in the form of the envelope pocket 125, that receives the item. The walls 122, 124 can be formed from other types of paper, including, for example, extensible paper; and from materials other than paper including, for example, plastics such as polyethylene film, in the alternative.

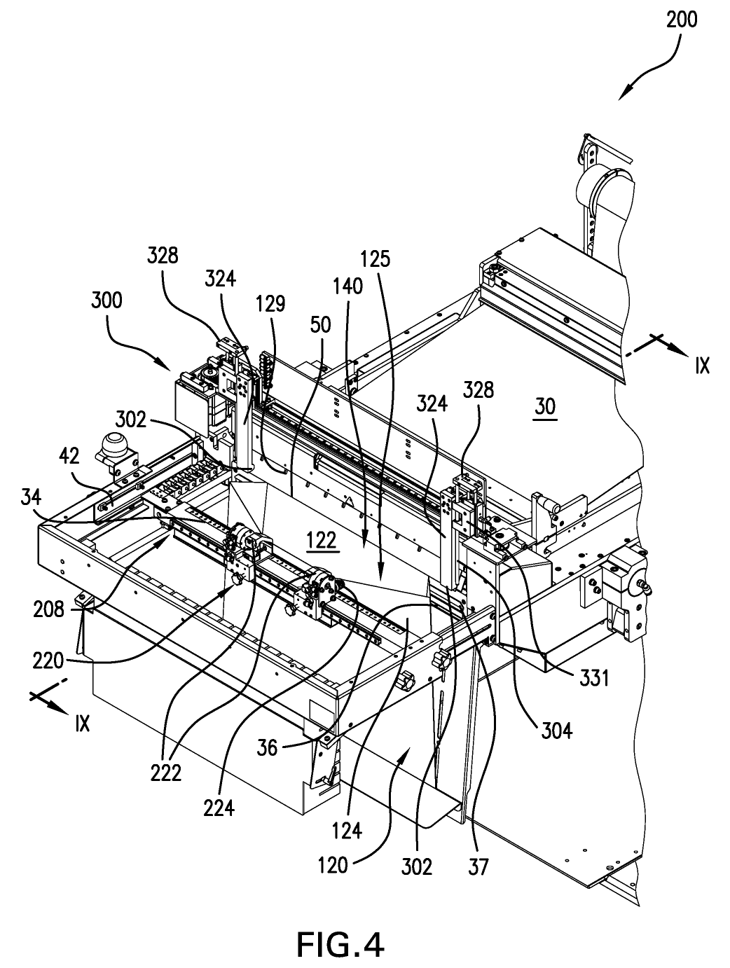

The envelope 120 also includes two inter-wall seals 126, and an inter-wall seal 128. The inter-wall seals 126, 128 can be formed from a bonding element. The bonding element can be, for example, a heat-activatable material, a pressure-sensitive adhesive, a cold glue, a cohesive material, etc. The inter-wall seals 126, 128 affix the walls 122, 124 to each other and define, in part, a pocket border of the envelope pocket 125. The envelope pocket 125 is visible in FIGS. 4-6. Each inter-wall seal 126 is located along a respective side or transverse edge 127 of the envelope 120, and extends continuously in a longitudinal direction of the envelope 120, along the entire length of the transverse edge 127. The longitudinal direction is denoted by the arrow “L” in FIG. 13. In alternative embodiments, the walls 122, 124 can be formed from a single sheet of C-folded paper or other material, with the overlapping transverse edges 127 of the sheet being fixed to each other by a single inter-wall seal 126.

The inter-wall seal 128 extends continuously along the bottom edge of the envelope 120, in a transverse direction, i.e., in a direction substantially perpendicular to the longitudinal direction, and intersects the inter-wall seals 126. The transverse direction is denoted by the arrow “T” in FIG. 13.

The opening 140 is located at the top of the envelope 120, and permits the item to be packaged to be inserted into the envelope pocket 125. More specifically, the wall 124 overlies the wall 122 and is affixed to the wall 122 about at least a portion of a pocket border defined by the inter-wall seals 126, 128, with the pocket border enclosing the envelope pocket 125 defined between the walls 122, 124, and with at least one of the walls 122, 124 defining the opening 140 which allows access to the envelope pocket 125 from an exterior of the envelope 120 for loading the item into the envelope pocket 125, when the envelope 120 is unsealed.

A sealing material in the form of a closure-sealing element 230 is disposed on an inwardly-facing surface of the wall 122, i.e., on the surface of the wall 122 that faces the wall 124, proximate the upper end of the wall 122. The term “proximate,” as used herein, is intended to encompass locations at, and near the location being referenced.

The upper edge of the closure-sealing element 230 can be offset from the upper edge of the wall 122 by, for example, about 0.75 inch to about 0.9 inch. The closure-sealing element 230 can be offset from the upper edge of the wall 122 by other distances in alternative embodiments. In other alternative embodiments, the upper edge of the closure-sealing element 230 can be approximately co-incident with the upper edge of the wall 122.

The closure-sealing element 230 can be, for example, a heat-activatable material, a pressure-sensitive adhesive, a cold glue, a cohesive material, etc. The heat-activatable material can be, for example, a heat sealable material or a hot-melt adhesive that, upon being heated and pressed, forms a closure seal (not shown) that adheres the wall 124 to the wall 122. The closure seal thus maintains the opening 140 in a closed state. Also, the closure seal forms another portion of the pocket border, so that the pocket border completely circumscribes the envelope pocket 125 to retain the packaged item within the envelope pocket 125. Thus, prior to formation of the closure seal, the envelope pocket 125 is closed on three sides and open on the fourth side, with the fourth side being closed upon formation of the closure seal. The closure-sealing element 230 and the adjacent portions of the first and second walls 122, 124 define a sealing region on the envelope 120.

The closure-sealing element 230 can be disposed on the wall 124 in alternative embodiments. In other alternative embodiments, a closure-sealing element 230 can be disposed on each of the walls 122, 124.

Hot-melt adhesives are thermoplastic polymers that are solid at room temperature, become molten when heated to an activation temperature above their softening point, and resolidify upon loss of heat at a temperature below a solidifying point, which may be the same as or different than the activation temperature, increasing in strength as they re-solidify. Most hot-melt adhesives, upon melting into a molten state and re-solidifying, do not undergo any chemical reaction such as cross-linking or removal of a carrier, e.g., evaporation of water. Thus, hot-melt adhesives typically can be reactivated, i.e., re-melted and re-solidified, after initially being applied to a substrate.

The hot-melt adhesive, after being applied to the surface to be bonded, can be in a low-tackiness state in which it has a low, or no tackiness in a lower range of temperatures. The hot-melt adhesive is reactivatable. More specifically, the hot-melt adhesive is applied hot, and cools and cures in the converting process. The hot-melt adhesive is reactivated by re-heating the hot-melt adhesive up to an activation temperature within a lower range of temperatures. This lower range of application temperatures in some embodiments, for example, is below about 140 °F. In other embodiments, for example, the lower range of temperatures is below about 120 °F, below about 125 °F, or below about 130 °F.

The re-heating of the hot-melt adhesive to the activation temperature causes the hot-melt adhesive to become molten. The subsequent cooling of the hot-melt adhesive, in combination with the application of pressure, causes the hot-melt adhesive to bond to the opposing surface, forming a seal between the surfaces.

A heat seal typically is formed by sealing one thermoplastic to the same or a similar thermoplastic. The thermoplastic material(s) typically is applied to the two substrates to be fixed to each other. At the time the substrates are to be fixed, the thermoplastic material(s) on one or both substrates is subject to heat and pressure sufficient to weld the materials together, thereby fixing the substrates to each other.

The heat-activatable material can be, for example, a heat sealable material. Heat sealable materials are pre-applied on the opposing surfaces of the substrates that are to be sealed together, typically as a coating applied to each surface. In some embodiments, the heat sealable material can be applied as a tape. The heat sealable material, after application, typically is solid in form.

An example of a heat sealable coating material is a weldable polymer provided in a thickness and with a composition such that upon applying sufficient heat to the coating and pressure to the substrates to pressure the opposing coatings against each other, the heat sealable material of the coatings melts and becomes welded together upon cooling, thereby forming a heat-seal of one substrate to the other. Typical heat sealable coatings are made of thermoplastics. The heat sealable material on the opposing surfaces of the substrates typically is identical. In some embodiments, non-identical materials can be used in the coating provided the materials are similar enough such that the materials can melt and combine to become welded together upon cooling.

In some embodiments, the heat-sealable material can include emulsion-based polymers and polymer dispersions. The one or more polymers can include one or more of vinyl acetate ethylene, polyvinyl acetate, polyvinyl alcohol, polyvinyl acetate copolymers, polyvinyl alcohol copolymers, dextrin stabilized polyvinyl acetate, vinyl acetate copolymers, ethylene copolymers, vinylacrylic, styrene acrylic, acrylic, styrene butyl rubber, polyurethane, polyolefins, and biodegradable materials (e.g., cellulose and starch). For example, the heat-activatable material can be a polyvinyl alcohol (PVOH) coating. In some applications, the PVOH can be coated with polyethylene (PE) or polylactic acid (PLA) to prevent the PVOH from sticking, or from absorbing moisture which causes sticking.

In some embodiments, the heat-sealable material can include a polyolefin-based dispersion. The polyolefin dispersion can include polyethylene and/or polypropylene, thermoplastic polymers, polymeric stabilizing agents including at least one polar polymer, water, and/or other suitable polyolefin dispersions. A suitable polyolefin dispersion can include, for example, HYPOD™, available from Dow Chemical, or other suitable polyolefin dispersions.

In some embodiments, the heat-sealable material can be water-based. The water-based heat-sealable material may include a water-based polymer. The use of a water-based heat-sealable material can enhance the recyclability of the envelope 120, since the water-based heat-sealable material can be dissolved and separated easily from the paper pulp during the recycling process.

As another example, the heat-activatable material can be an expandable material that expands when subjected to an elevated temperature. The expandable material, when expanded, can provide an additional cushioning effect to the envelopes 120. For example, an expandable material can be provided by depositing an expansion element on to the surface of a fluid adhesive. When activated, the expansion element creates voids in the adhesive, producing a foamed adhesive. Microspheres filled with a gas, such as nitrogen, for example, can be used as the expansion element. When heated, such as by subjecting the microspheres to microwave or other radiation, the expandable material expands and can provide a cushioning effect.

A cohesive material includes a bonding material that causes one surface to stick to an opposing surface by coming into contact with the same or a complimentary cohesive substance to form the bond between the two surfaces. Cohesives do not stick to other substances sufficiently to adhere to those other substances, or in some cases stick very weakly compared to the bond they form from sticking to each other.

Referring still to FIG. 13, the envelopes 120 can be in the form of single envelopes, or can be pre-formed as part of a continuous web 30. The web 30 can be formed from two sheets of paper having a basis weight of, for example, about 55 lb. to about 78 lb. (about 55 lb. per 3,000 square feet to about 78 lb. per 3,000 square feet). The sheets can have a basis weight above or below this range in alternative embodiments of the web 30. The sheets are joined along the respective transverse edge portions thereof by the inter-wall seals 126. The web 30 can be formed from other types of material, such as polyethylene, in the alternative. In alternative embodiments, the web 30 can be formed from a single sheet of C-folded paper or other material, with the overlapping transverse edge portions of the sheet fixed to each other by a single inter-wall seal 126. In applications where one or both of the walls 122, 124 of the envelope 120 are multi-ply walls, the web 30 can be formed from multiple sheets joined by inter-ply seals so as to provide the multi-ply configuration to one or both of the walls 122, 124.

Regions of weakness can be formed in the web 30, between each of the envelopes 120 in the web 30. The region of weakness can be formed, for example, as a series of perforations 50 that extend transversely across the wall 122 of each envelope 120 in the web 30, between the longitudinal inter-wall seals of the web 30. The region of weakness can be formed in other ways, such as scoring, in the alternative.

Cuts can be formed in the web 30, directly below, i.e., downstream of, the perforations 50. The cuts can be, for example, kiss cuts 51. The kiss cuts 51 can be formed in the wall 124 of each envelope 120, and can be longitudinally spaced from their associated perforations 50 in the wall 122 by, for example, about 1/8 inch to about 3/16 inch in the longitudinal direction of the web 30. The kiss cuts 51 permit the top edge of the wall 124 to be separated, i.e., pulled away from, the wall 122 to form the opening 140 in the envelope 120. In alternative embodiments, the kiss cuts 51 and the perforations 50 can overlap, i.e., the kiss cuts 51 and the perforations 50 can be formed at the same longitudinal locations along the web 30.

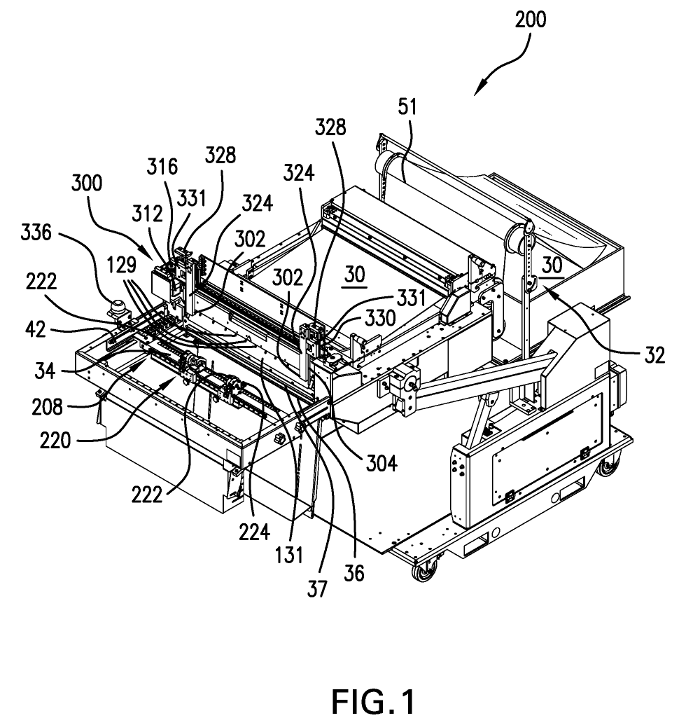

The web 30 can be provided in a fan-folded configuration, as shown in FIGS. 1-7, with the fan-folded web 30 forming a material supply 32. Alternatively, the web 30 can be provided in a rolled configuration (not shown).

The bagging machine 200 and the multimodal sealer 210 can be used with webs having configurations other than that of the web 30. For example, the multimodal sealer 210 can be used in bagging machines that receive and seal individual envelopes instead of a web of envelopes.

The bagging machine 200 is configured to receive the web 30 of preformed envelopes 120; to form the opening 140 in each envelope 120 to provide access the envelope pocket 125 so that the item to be packaged can be loaded into the envelope pocket 125; to seal the loaded envelope 120; and to separate the envelope 120 from the web 30.

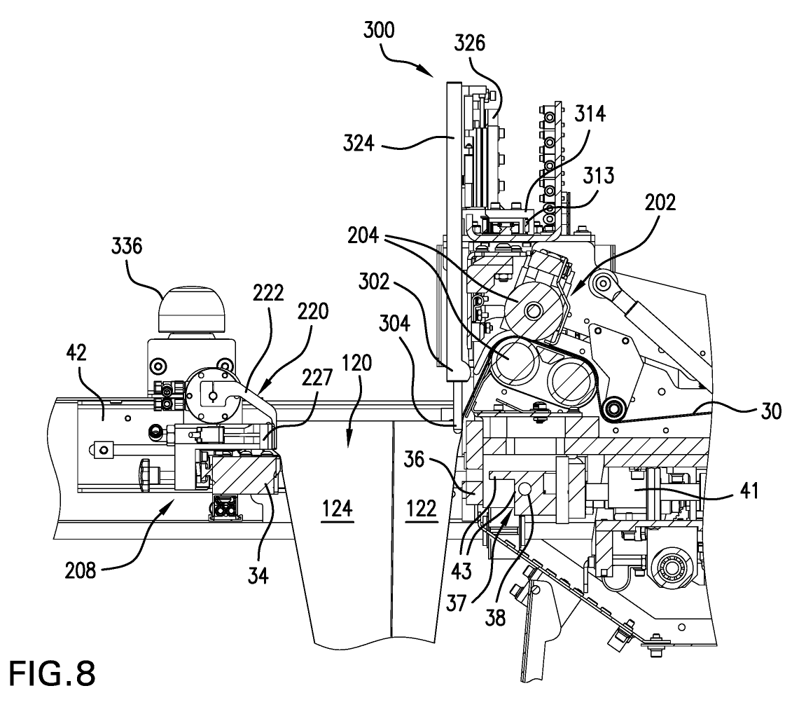

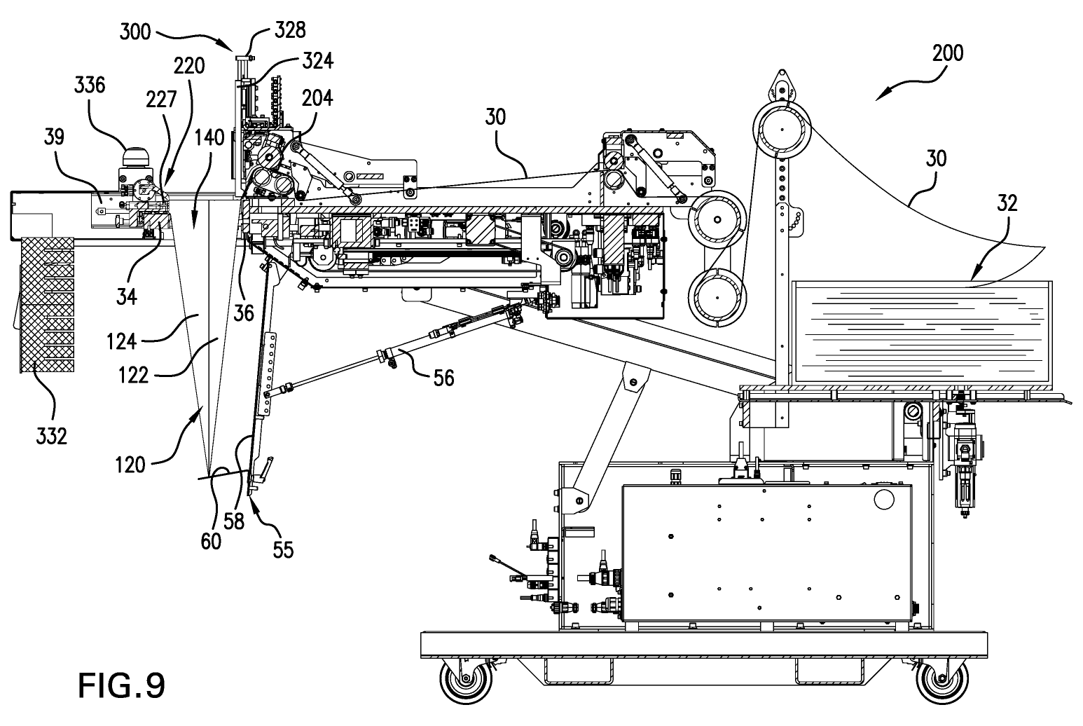

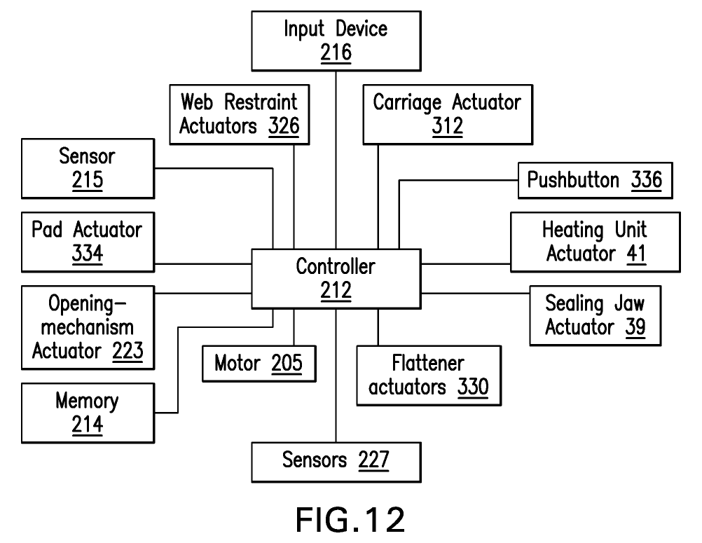

The bagging machine 200 includes a web advancement mechanism 202. The web advancement mechanism 202 is shown in part in FIGS. 8 and 9, and is configured to advance the web 30 in a downstream direction and in the longitudinal direction of the web 30. The web advancement mechanism 202 can include, for example, a pair of nip rollers 204 driven by a motor 205. The motor 205 is depicted diagrammatically in FIG. 12, and is communicatively coupled to the controller 212 (also shown in FIG. 12). The web advancement mechanism 202 can be configured with wheels, paddles, teeth, etc. to advance the web 30, in lieu of the nip rollers 204.

The sealer 208 is depicted in FIGS. 1-9. The sealer 208 is configured to form the closure seal in the envelope 120 being loaded. The sealer 208 includes a pressure bar or sealing jaw 34, an anvil 36, and a track 42. The sealer 208 also includes a sealing jaw actuator 39. The sealing jaw actuator 39 is communicatively coupled to a controller 212 of the bagging machine 200. The sealing jaw actuator 39 and the controller 212 are depicted diagrammatically in FIG. 12.

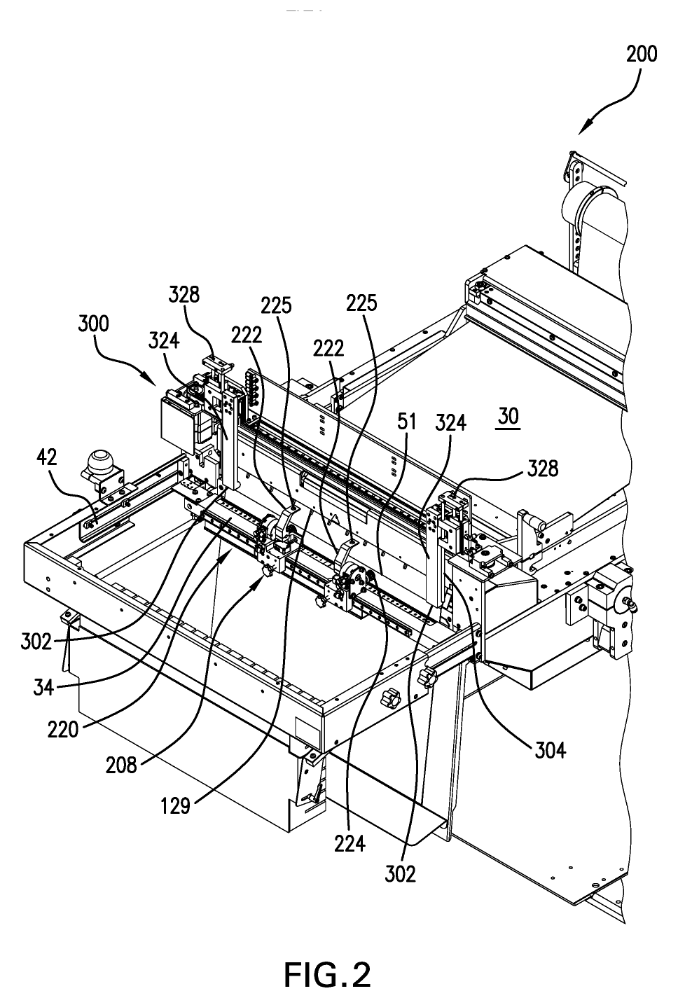

The sealing jaw 34 is mounted on the track 42, and is configured to slide on the track 42. The sealing jaw actuator 39 is configured to move the sealing jaw 34 horizontally, toward and away from the anvil 36 between a first, or open position shown in FIGS. 1, 4-6, 8, and 9; and a second or closed position shown in FIGS. 2, 3, and 7. When the sealing jaw 34 is in the closed position, pressure can be applied to the closure-sealing element 230 of the envelope 120, resulting in the formation of the closure seal that seals the envelope pocket 125 closed. The sealing jaw actuator 39 can be a pneumatic actuator. The sealing jaw actuator 39 can be a hydraulic actuator, an electrical actuator, or another type of actuator in alternative embodiments.

The sealing jaw 34 also can heat the closure-sealing element 230 to form the closure seal. The sealer 208 includes a heat source in the form of a heating unit 37 mounted on the anvil 36. In alternative embodiments, the heat source can include two heating units 37 mounted respectively on the sealing jaw 34 and the anvil 36. The heating unit 37 includes a heating element 38, and a heating bar 43 formed around the heating element 38. The heating element 38 can be, for example, a heated wire. Other types of heating techniques, such as a radiative or ultrasonic heating or heated air, can be used in lieu of a heated wire in alternative embodiments.

The heating bar 43 is heated by the heating element 38, and acts as a heated mass that transfers the heat generated by the heating element 38 to the envelope 120 when the heating bar 43 is driven into contact with the envelope 120 as discussed below.

The heating unit 37 is configured to retract into the anvil 36 as shown in FIG. 8, to help prevent the operator from touching or otherwise coming into contact with the heating unit 37. The sealer 208 includes a heating unit actuator 41 communicatively coupled to controller 212 and configured to move the heating unit 37 outward, and out of the anvil 36 when the sealing jaw 34 is in its closed position, so that the heating bar 43 can contact the wall 122 of the envelope 120 and heat the closure-sealing element 230 through the wall 122. The heating unit actuator 41 is visible in FIG. 8 and is depicted diagrammatically in FIG. 12. The heating unit 37 can be non-movable in alternative embodiments. In other alternative embodiments, the heating unit 37 can be covered by a movable guard configured to retract so as to expose the heating unit 37 as the sealing jaw 34 moves to its closed position.

The sealer 208 can have other configurations in alternative embodiments. For example, the sealer can have the configuration disclosed in Patent Cooperation Treaty application no. PCT/US2025/043537, the contents of which are incorporated by reference herein in their entirety.

The bagging machine 200 also comprises a wall handling device 220 shown in FIGS. 1-9. The wall handling device 220 is configured to grasp the wall 124 of the downstream envelope 120, i.e., the envelope 120 located at the leading, or downstream end of the web 30, and to pull the wall 124 away from the wall 122 in an opening direction to define the opening 140 to the interior pocket of the envelope 120. The wall handling device 220 can include, for example, two grips 222. Alternative embodiments can include one, or more than two grips 222. The wall handling device 220 also can include one or more suction cups 224 in fluid communication with a vacuum source (not shown).

The grips 222 and the suction cups 224 are mounted on, and translate with the sealing jaw 34. As discussed below, when the envelope 120 is to be opened, the sealing jaw 34 is moved inward, to its closed position, so that the suction cups 224 are brought into contact with the outwardly-facing surface of the envelope wall 124. The vacuum provided to the suction cups 224 causes the suction cups 224 to engage the wall 124. The suction cups 224 pull the wall 124 outwardly, away from the wall 122 and out of its original plane, as the sealing jaw 34 subsequently is moved outwardly, away from its closed position. The suction cups 224 thus open the envelope 120 slightly, to pre-form the opening 140. The bagging machine 200 can include an air blower (not shown) configured to direct air onto the wall 124 to aid in pre-forming the opening 140. Alternative embodiments of the bagging machine 200 can be configured without the air blower.

The grips 222 are configured to rotate between a raised, or upper position shown in FIG. 2, and a lower, or closed position shown FIGS. 1 and 3-9. The wall handling device 220 includes an actuator 223 communicatively coupled to the controller 212 and configured to rotate the grips 222 between the open and closed positions. The actuator 223 is depicted diagrammatically in FIG. 12. The controller 212 causes the actuator 223 to rotate the grips 222 from the raised position to the closed position as the sealing jaw 34 is move further outward, away from its closed position, so that the grips 222 enter the pre-formed opening in the downstream envelope 120 and grasp the inwardly-facing surface of the wall 124, i.e., the surface of the wall 124 that faces the wall 122, proximate the upper edge of the wall 124. At this point, further outward movement of the sealing jaw 34 causes the grips 222 and the suction cups 224 to draw the wall 124 further outward, in the opening direction, to form the opening 140 into, for example, a hexagonal shape as shown in FIG. 4. As can be seen in FIG. 4, the outward portions of the wall 124 have been moved out of their original respective planes by a steep angle, e.g., by about 30° or more.

The wall handling device 220 also includes two sensors 227 communicatively coupled to the controller 212. The sensors 227 are depicted FIGS. 8, 9, and 12. Each sensor 227 is mounted proximate an associated grip 222. Each grip 222 has an opening 225 formed therein, proximate the freestanding end of the grip 222. The openings 225 are configured to align with the sensing axis of the corresponding sensors 227 when the grips 222 are in their closed positions. Each sensor 227 is configured to sense the presence of the wall 124 when the freestanding end of the grip 222 is in contact with the wall 124 of the envelope 120, and to generate an output indicating the presence of the wall 124 under the grip 222.

Alternative embodiments of the bagging machine 200 can be equipped with grips that disengage automatically from the mechanism that rotates the grips when the grips jam or otherwise encounter a condition that subjects the grips to substantial resistance to rotation, as described in Patent Cooperation Treaty application no. PCT/US2025/043537.

Referring to FIGS. 1, 10, and 11, the bagging machine 200 also includes a breaking element and seal flattener assembly 300. The bagging machine 200 is described in connection with the breaking element and seal flattener assembly 300 for illustrative purposes only. Alternative embodiments of the bagging machine 200 can be configured without the breaking element and seal flattener assembly 300.

The assembly 300 includes a breaking element in the form of, for example, a web restraint. The web restraint comprises two web restraint portions 302; two arms 324, two actuators 326, and two carriages 314. As discussed below, the breaking element is configured to promote tearing along the region of weakness in the web 30 to facilitate separation of the downstream envelope 120 from a remainder portion of the web 30.

Each web restraint portion 302 is fixed to a lower end of a corresponding arm 324. An upper end portion of each arm 324 is coupled to a vertically-oriented face of a corresponding actuator 326. Each actuator 326 is mounted on a corresponding carriage 314. As discussed below, the carriages 314 are driven in the transverse direction, i.e., transverse to the longitudinal or lengthwise direction of the web 30, so as to move the actuators 326, and their associated arms 324 and web restraint portions 302, in the transverse direction.

The actuators 326 are communicatively coupled to the controller 212. The actuators 326 are configured to move their associated arms 324 vertically, in response to inputs from the controller 212. This movement causes the associated web restraint portions 302 to move vertically, in relation to the base 310, between an upper, or disengaged position shown in FIGS. 1, 6-11, 14, and 16; and a lower, or engaged position shown in FIGS. 2-4 and 11.

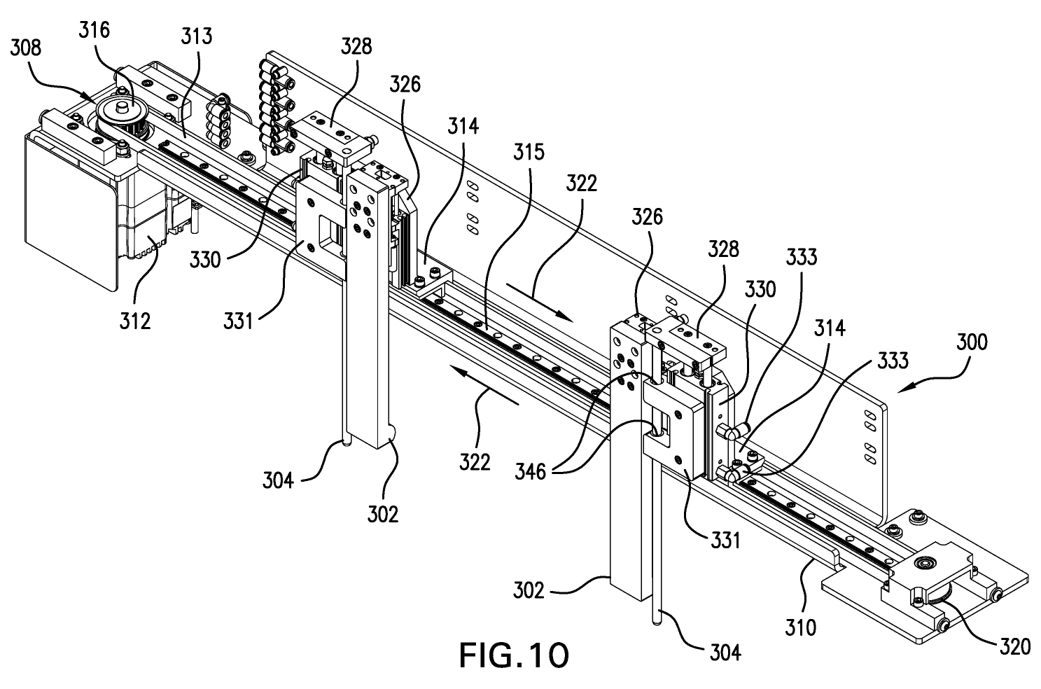

The web restraint portions 302 are configured to contact the web 30 when the web restraint portions 302 are in their lower positions. More specifically, each web restraint 302 has a contact surface configured to engage the web 30 when the web restraint 302 is in its lower position. The contact surface is depicted in FIGS. 8 and 10. As shown in FIG. 9, each web restraint 302 opposes, and is closely spaced from an upwardly-facing surface of the guide bar 131 when the web restraint portions 302 are in their lower positions.

Also, the web restraint portions 302 engage the web 30 proximate the respective transverse edges of the web 30, as shown in FIGS. 2-4. Each hold down 302 has a width, or transverse dimension, large enough to distribute the force exerted by the web restraint portion 302 on the web 30 across a sufficient portion of the web 30 so as to avoid tearing of the web 30 as the web restraint portion 302 restrains the web 30 in the below-described manner. The width of each web restraint portions 302 is small enough, however, to permit the web restraint portions 302 to move in the transverse direction as described below without interfering with each other, or with other components of the assembly 300.

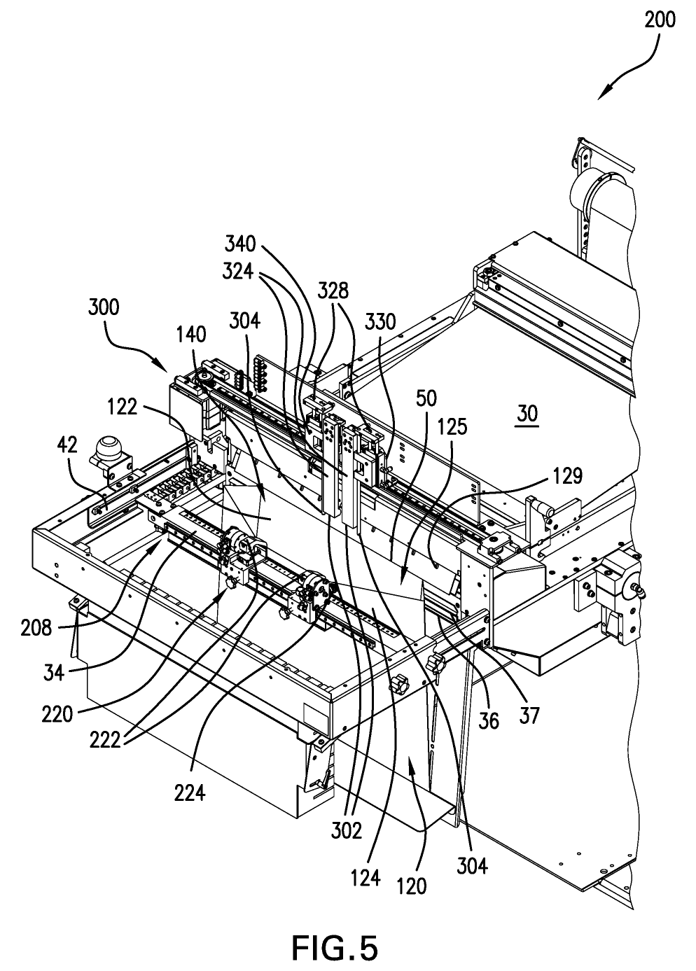

The engagement of the web restraint portions 302 and the web 30 restrains the web 30 at respective restraining locations as the envelope 120 to be loaded, i.e., the downstream envelope 120, is opened by the wall handling device 220, i.e., as the wall 124 of the downstream envelope 120 is pulled out of its original plane and away from the wall 122 of the downstream envelope 120. More specifically, the web restraint portions 302 are configured to restrain the web 30 directly upstream of the line of perforations 50 between the downstream envelope 120 and the adjacent envelope 120 in the web 30, proximate, i.e., at or near, the transverse edges 127 of the web 30. As a result of this restraint, and the association of the wall handling device 220 and the web restraint portions 302, the pulling of the wall 124 away from the wall 122 in the opening direction causes the ties of the perforations 50 proximate the transverse edges of the wall 122 to tear or break, with the tear progressing inwardly as the wall 124 is pulled further from the wall 122 until most, or all of the ties located between the transverse edges 127 and the respective web restraint portions 302 are torn or broken, and with the ties of the perforations 50 in the central portion of the wall 124 remaining intact, as can be seen in FIG. 5. This partial tearing or breaking of the ties along of the line of perforations 50 allows the opening 140 in the envelope 120 to assume the approximately hexagonal shape as shown in FIG. 5, which in turn facilitates the formation of a relatively large opening 140 without imparting excessive stress to the inter-wall seals 126 along the transverse edges 127 of the web 30.

As can be seen in FIG. 5, the grips 222 are associated with the web restraint portions 302 to move in an opening direction away from the breaking element to pull the wall 124 away from the wall 122 and the upstream envelope 120 to form the opening 140 in the downstream envelope 120 through which the item can be inserted into the interior pocket 125 of the envelope 120 between the walls 122, 124. Also, the movement of the wall 124 in the opening direction causes the wall 124 to be drawn away from a reference line (not shown) extending in the transverse direction of the web 30 and passing through the restrained areas at which the web 30 has been restrained by the web restraint portions 302.

As can be seen in FIG. 5, the restrained areas on a remainder portion of the web 30, i.e., a portion of the web 30 that remains part of the web 30 after the downstream envelope 120 has been fully or partially separated from the web 30, are sufficiently near the region of weakness, i.e., the line of perforations 50, in the longitudinal direction of the web 30 such that the breaking element, e.g., the web restraint portions 302, restrain the remainder portion against movement in the opening direction as the wall handling device 220 pulls the wall 124 in the opening direction, thereby causing the wall 122 to tear progressively from the remainder portion as the wall handling device 220 pulls the wall 124 in the opening direction.

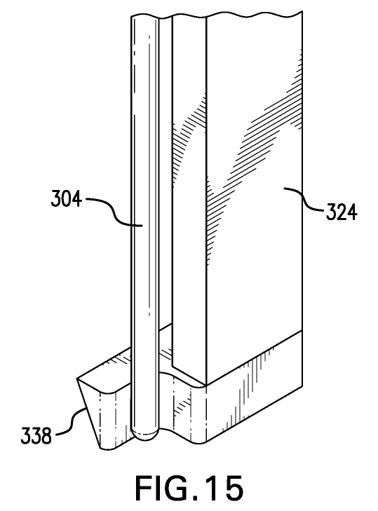

The breaking element can have configurations other than that described above in alternative embodiments. For example, the breaking element can be configured as one or more blades, plates, rods, grips, punches, etc. in alternative embodiments. As another example, FIG. 15 depicts an alternative embodiment of the breaking element in the form of a web restraint portion 338 that includes a lip that partially surrounds the lower end of an associated flattening portion 304 (described below), to increase the width, or transverse dimension, of the web restraint portion 302, which in turn increases the contact area between the web restraint portion 338 and the web 30.

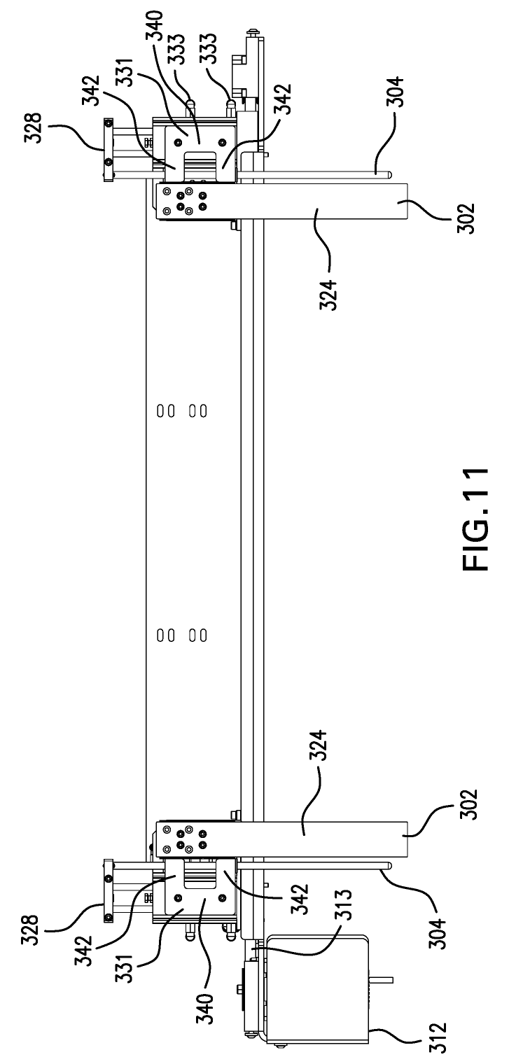

Referring to FIGS. 10 and 11, the breaking element and seal flattener assembly 300 also includes a seal flattener comprising, for example, two flattening portions 304 configured to smooth the sealing area on the wall 122, i.e., the area on the wall 122 at which the closure seal subsequently will be formed from the closure-sealing element 230, after the opening 140 has been formed, so as to reduce or eliminate wrinkles in a closure area where the walls 122, 124 are brought together. The smoothing of the sealing area can enhance the integrity and sealing effectiveness of the closure seal. Alternative embodiments can include less, or more than two, flattening portions 304.

The breaking element and seal flattener assembly 300 also comprises two mounts 328, two flattener actuators 330, and two guide blocks 331. An upper end of each flattening portion 304 is fixed to an associated mount 328. The mount 328 is coupled to an associated flattener actuator 330. Each flattener actuator 330 is mounted on an associated carriage 314. Each flattener actuator 330, and its associated mount 328 and flattening portion 304, thus travel in the transverse direction along with an associated web restraint portion 302, arm 324, and web restraint actuator 326.

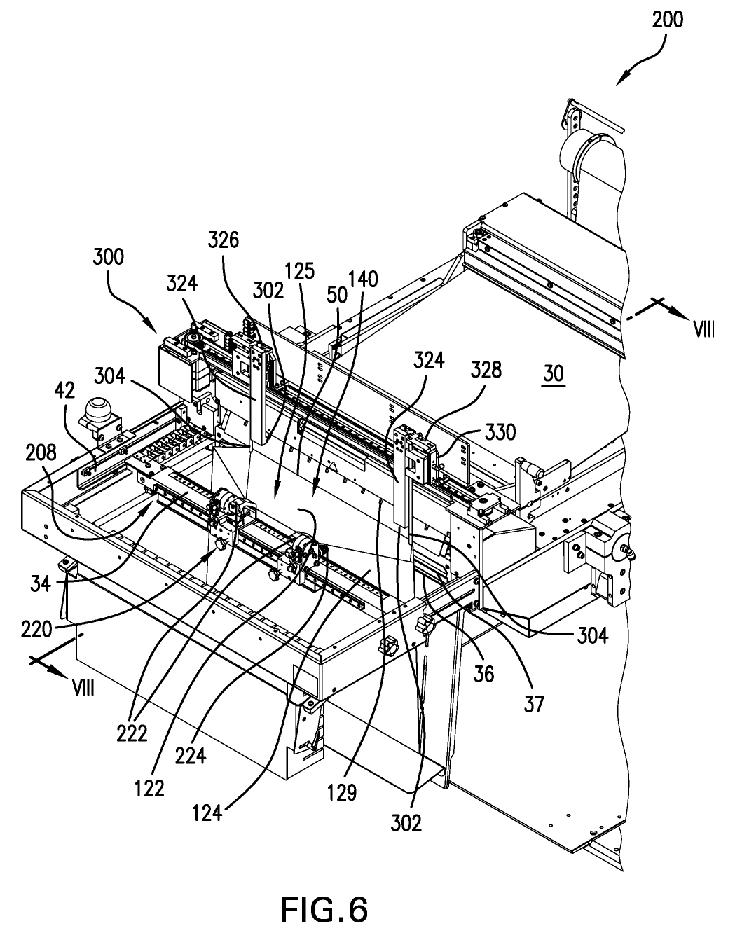

The flattener actuators 330 are communicatively coupled to the controller 212. Each flattener actuator 330 is configured to move its corresponding mount 328 vertically in response to inputs from the controller 212, so that the flattening portions 304 move vertically in relation of the base 310 between an upper, or disengaged position shown in FIGS. 1-5, 7, 10, and 11; and a lower, or engaged position shown in FIGS. 6 and 8. The flattener actuators 330 are pneumatic actuators, and can be supplied with pressurized air via pneumatic fittings 333 visible in FIG. 10. Other types of actuators, such as electric actuators, hydraulic actuators, etc., can be used in alternative embodiments. In other alternative embodiments, the flattener actuators 330 can be rotary actuators that rotate the flattening portions 304 into and out of their respective lower positions.

The flattening portions 304 are configured as vertically-oriented, cylindrical rods having a rounded lower surface. The rods can have an orientation other than vertical in alternative embodiments. Also, the flattening portions 304 can have other configurations in alternative embodiments. The flattening portions 304 can have a protective and/or friction-reducing coating, such as polytetrafluoroethylene (PTFE). The flattening portions 304 can be uncoated in alternative embodiments.

The flattening portions 304 are configured to contact the web 30 when the flattening portions 304 are in their lower positions. More specifically, the flattening portions 304 are configured to contact the inwardly-facing surface of the wall 122 of the downstream envelope 120 after the opening 140 has been formed in the envelope 120 in the above-described manner, proximate the sealing area. As discussed below, the flattening portions 304 are configured to move transversely while in contact with the web 30, from an initial position proximate the centerline of the web 30, so that the flattening portions 304 smooth, or flatten the upper portion of the wall 122, including the sealing area.

Each guide block 331 is fixed to a corresponding mount 328. The guide blocks 331 each include a vertical portion 340, and two horizontal portions 342 as shown in FIGS. 9 and 10. The horizontal portions 342 adjoin, and extend from the respective upper and lower ends of the vertical portion 340, giving the guide block 331 a substantially C-shaped configuration. Each horizontal portion 342 has a through hole formed therein. A respective bushing 346 is positioned within each through hole. Each flattening portion 304 extends through the bushings 346 in its associated guide block 331, as depicted in FIG. 10. The clearance between the bushings 346 and the flattening portion 304 is minimal, so that the guide block 331 and the bushings 346 help to maintain the flattening portion 304 in a vertical orientation as the flattening portion 304 moves transversely across the web 30 while in contact with the web 30.

Referring still to FIGS. 10 and 11, the assembly 300 further includes a carriage mechanism 308 configured to move the web restraint portions 302 and the flattening portions 304 transversely in relation to the lengthwise direction of the web 30. The following description of the carriage mechanism 308 is presented for illustrative purposes only. The web restraint portions 302 and the flattening portions 304 can be moved using other mechanisms or devices in alternative embodiments.

The carriage mechanism 308 comprises the carriages 314, a base 310, a carriage actuator 312 mounted on the base 310, a drive belt 313, and a guide rail 315 fixed to the base 310.

The carriages 314 are configured to translate in relation to the base 310, in the transverse direction. Each carriage 314 engages the guide rail 315, which guides the carriage 314 along a linear path in the lengthwise direction of the base 310. The carriages 314 are configured to slide along the guide rail 315. In alternative embodiments, the carriages 314 can ride on bearings located between the carriages 314 and the guide rail 315.

As discussed above, one of actuators 326 is associated with the web restraint portion 302, and one of the flattener actuators 330 is associated with the flattening portions 304, are mounted on each of the carriages 314, so that the transverse movement of the carriage 314 causes its associated web restraint portion 302 and flattening portion 304 to move transversely, in tandem with each other.

The carriage actuator 312 is coupled to a grooved drive wheel 316 of the trolley mechanism 308, so that the carriage actuator 312 rotates the drive wheel 316. The carriage actuator 312 can be, for example, a reversible electric motor communicatively coupled to a controller 212. The carriage actuator 312 can be configured as another type of actuator, such as a pneumatic actuator, a hydraulic actuator, etc., in alternative embodiments. The carriage actuator 312 is configured to rotate the drive wheel 316 in the clockwise and counterclockwise directions, in response to inputs from the controller 212.

The trolley mechanism 308 further comprises a guide wheel 320 mounted on, and configured to rotate in relation to the base 310. The guide wheel 320 and the drive wheel 316 are mounted on opposite ends of the base 310, as can be seen in FIG. 10.

The drive belt 313 is coupled to the drive wheel 316 and the guide wheel 320, so that the activation of the carriage actuator 312 causes the drive belt 313 to move along a path between the rotating drive wheel 316 and the guide wheel 320, with opposite sides of the drive belt 313 moving in opposite directions in relation to the base 310, as denoted by the arrows 322 in FIG. 10 (the drive belt 313 also can move in directions opposite those denoted by the arrows 322, when the carriage actuator 312 is reversed).

Each carriage 314 is configured to clamp itself to the drive belt 313 so that the carriages 314 move linearly in relation to the base 310 in response to the movement of the drive belt 313. For example, each carriage 314 can include grabbing block having teeth formed thereon, and a clamp block that clamps the drive belt 313 down to the teeth. The engagement of the carriages 314 and the guide rail 315 causes the carriages 314 to move along respective linear paths in the lengthwise direction of the base 310, i.e., in the transverse direction. The carriages 314 are clamped to opposite sides of the drive belt 313, so that the carriages 314 (and their associated web restraint portions 302 and flattening portions 304) move in opposite directions in relation to each other in a mirrored manner when the drive belt 313 is in motion.

The carriage mechanism 308 is configured to move the web restraint portions 302 and the flattening portions 304 transversely, between an outward position shown in FIGS. 1-4, 7, 10, and 11; and an inward position shown in FIG. 5. As can be seen in FIG. 5, the web restraint portions 302 and the flattening portions 304 are located proximate the longitudinal centerline of the web 30 when in their respective inward positions. As can be seen in FIGS. 1-4, the web restraint portions 302 and the flattening portions 304 are located proximate the transverse edges 127 of the web 30 when in their respective outward positions.

As noted above, because each web restraint 302 is mounted on one of the carriages 314 with an associated flattening portion 304, each web restraint 302 and its corresponding flattening portion 304 move between their respective outward and inward positions in tandem. Also, because the carriages 314 are connected to opposite sides of the drive belt 313, and the opposite sides of the drive belt 313 move in opposite directions in response to the rotation of the drive wheel 316 by the carriage actuator 312, both web restraint portions 302 and both flattening portions 304 move to their respective outward positions when the carriage actuator 312 rotates the drive wheel 316 in a first angular direction. Likewise, both web restraint portions 302 and both flattening portions 304 move to their respective inward positions when the carriage actuator 312 rotates the drive wheel 316 in a second angular direction opposite the first angular direction.

The web restraint portions 302 and flattening portions 304 can be driven in the transverse direction by devices or mechanisms other than the trolley mechanism 308, in alternative embodiments. For example, each web restraint 302 and is associated flattening portion 304 can be driven directly in the transverse direction by a linear actuator, such as a linear pneumatic or a linear hydraulic actuator, without a drive belt 313, in alternative embodiments. In other alternative embodiments, each web restraint portion 302 can be mounted on the jaw 34 along with an associated actuator configured to move the web restraint portions 302 horizontally, into contact with the upstream envelope 120.

After the envelope 120 has been loaded and sealed, the envelope 120 can be separated from the remainder of the web 30 by applying a pulling force to the web 30 upstream of the loaded and sealed envelope 120, to tear the region of weakness, i.e., the perforations 50. The pulling force can be created by reversing the direction of rotation the nip rollers 204 while the loaded and sealed envelope 120 is being restrained by the sealing jaw 34 and the anvil 36, so that the web 30 is drawn in the upstream direction so as to separate the loaded and sealed envelope 120 from the remainder of the web 30 along the region of weakness. In alternative embodiments, the loaded and sealed envelope 120 can be separated from the remainder of the web 30 using other techniques, such as one or more cutting edges configured to form a laceration along the region of weakness, the focused application of heat applied along the region of weakness, a heated wire, etc. In other alternative embodiments, the bagging machine 18 can include a web separator as disclosed in Patent Cooperation Treaty Application no. PCT/US2025/043537.

The controller 212 comprises a processor, such as a microprocessor. The controller 212 also includes a memory, such as a random access memory, communicatively coupled to the processor; and computer executable instructions stored on the memory. The processor is configured so that the processor upon executing the computer executable instructions, carries out the logical operations of the controller 212 described herein. The controller 212 also comprises an internal bus that facilitates communications between the various components of the controller; and an input-output interface communicatively coupled to the processor. The controller 212 can include additional components, a description of which is not necessary to an understanding of the technology disclosed herein. The above description of the controller 212 is presented for illustrative purposes only. The controller 212 can have other configurations in alternative embodiments.

Referring to FIG. 1, at the start of an operational cycle of the bagging machine 200, the web restraint portions 302 and the flattening portions 304 are in their respective upper and outward positions, the sealing jaw 34 is in its open position, and the grips 222 are in their closed position. The cycle begins with the controller 212 causing the motor 205 of the web advancement mechanism 202 to actuate the nip rollers 204 so as to advance the web 30 in the downstream direction until the sealing area (corresponding to the location of the closure-sealing element 230) on the downstream envelope 120 is aligned with the sealing jaw 34 and the anvil 36 of the sealer 208, as shown in FIG. 2.

The amount of web 30 advancement to properly position the downstream envelope 120 may be programmed into the controller 212 based on the length of the envelope 120, i.e., the bagging machine 200 may, each time, advance the same amount of web 30, which corresponds to the length of one envelope 120. Alternatively, computer vision, e.g., one or more an optical sensors mounted on the grips 222, may be used to pause the advancement of the web 30 when the sealing area has been aligned with the sealing jaw 34 and the anvil 36.

As can be seen, for example, in FIG. 8, the bagging machine 200 includes a plurality of stationary grips 129 that help to guide the web 30 downwardly, beneath the web restraint portions 302 and the flattening portions 304, as the web 30 is advanced.

Once the envelope 120 has been properly positioned, the controller 212 activates the sealing jaw actuator 39 of the sealing jaw 34 to cause the sealing jaw 34 to move inward from its open position, toward the wall 124 of the envelope 120 (and the underlying anvil 36), so that the suction cups 224 of the sealer 208 come into contact the outwardly-facing surface of the wall 122, as depicted in FIG. 2.

At or about the time the sealing jaw 34 begins to move inward, the controller 212 causes the actuators 326 to move the web restraint portions 302 to their respective lower positions. As discussed above, the web restraint portions 302, when in their lower positions, engage the web 30 directly upstream of the downstream envelope 120, proximate the perforations 50 that separate the downstream envelope 120 from the adjacent envelope 120. Because the guide bar 131 is closely spaced from the inwardly-facing contact surfaces of the web restraint portions 302, when the web restraint portions 302 are in their lower positions, portions of the adjacent (upstream) envelope 120 proximate the transverse edges 127 thereof become sandwiched or trapped between the contact surfaces and the guide bar 131 when the web restraint portions 302 assume their lower positions, as shown in FIG. 9.

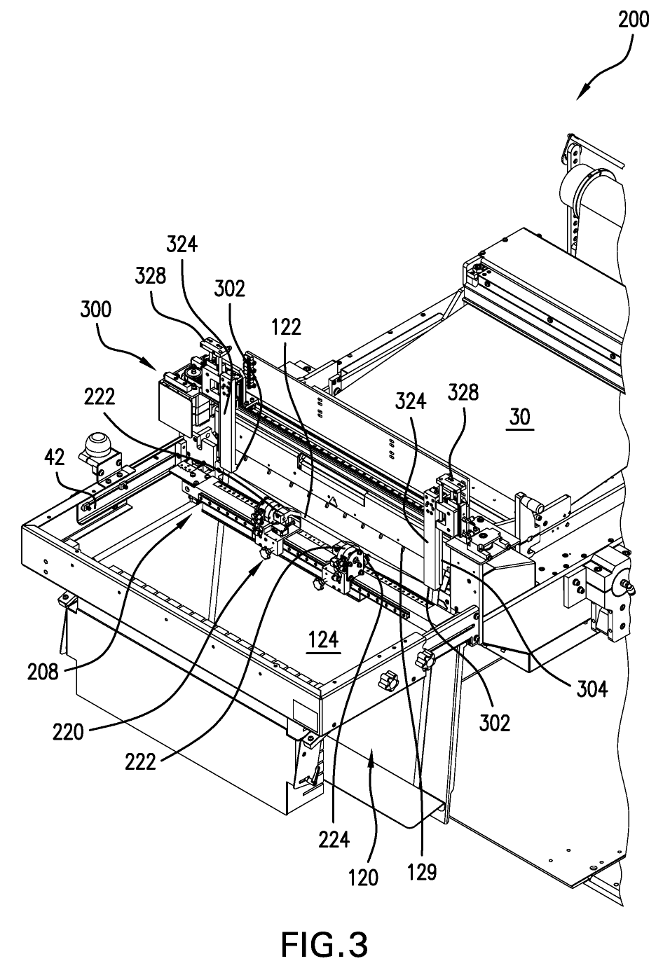

As can be seen in FIG. 2, the controller 212 causes the sealing jaw actuator 39 to rotate the grips 222 of the wall handling device 220 to their raised position prior by the time the sealing jaw 34 reaches its closed position. Once the sealing jaw 34 reaches its closed position, with the suction cups 224 of the wall handling device 220 in contact with second wall 124 of the downstream envelope 120 as shown in FIG. 3, the controller 212 causes the sealing jaw actuator 39 to move the sealing jaw 34 outward, toward its open position. The outward movement of the sealing jaw 34 causes the suction cups 224 to draw the second wall 124 away from the first wall 122 to pre-form the opening 140 in the envelope 120 in the above-noted manner, as depicted in FIG. 3. Once the opening 140 has been pre-formed, the controller 212 causes the actuator 223 to rotate the grips 222 downward into engagement with the wall 124, as also depicted in FIG. 3.

The controller 212 then causes the sealing jaw actuator 39 to continue to move the sealing jaw 34 outward, toward its open position. The movement of the sealing jaw 34 to its open position draws the wall 124 further from the wall 122 and further out of its original plane, forming the hexagonally-shaped opening 140 in the envelope 120 as shown in FIG. 4.

The web restraint portions 302 restrain the adjacent or upstream envelope 120 from movement in the outward direction, i.e., from movement in the direction denoted by the arrow 133 in FIG. 4, as the wall 124 of the downstream envelope 120 is moved outward by the grips 222 of the wall handling device 220 to form the opening 140. The force applied by the grips 222 to the wall 124 is transmitted to the opposite wall 122 by way of the portions of the inter-wall seals 126 located at and near the upper end of the downstream envelope 120. Because the perforations 50 in the wall 122 are located below, or downstream of the respective lines of restraint exerted by the web restraint portions 302, the force transmitted through the inter-wall seals 126 initially acts on the outermost perforations 50 on each side of the wall 122. Thus, the ties associated with the outermost perforations 50 are the first to break in response to the applied force. At this point, further outward movement of the wall 124 causes the adjacent ties to begin breaking, with the breaking proceeding sequentially inward along the region of weakness, until the outward movement of the wall 124 ceases as the opening 140 becomes fully formed.

In some embodiments, the front-to-back dimension of the fully-formed opening 140, i.e., the distance between the walls 122, 124, can be about 5.5 inches. This specific dimension is presented for illustrative purposes only. The optimal or desired dimension of the opening 140 is application dependent, and can vary with factors such as the size of the envelope 120, the size of the item being loaded into the envelope 120, etc. In some embodiments, the open position of the sealing jaw 34 can be varied to accommodate envelopes 120 of different sizes, and/or to facilitate the formation of differently sized openings 140 in the same type of envelope 120. For example, the open position of the sealing jaw 34 of the bagging machine 200 can be varied so that the front-to-back dimension of the fully-formed opening 140 can be as large as 12 inches.

At this point, the ties associated with the perforations 50 located at and near the outer edges of the region of weakness have broken, while the ties associated with the perforations 50 located in the center of the region of weakness have remained intact, as can be seen in FIG. 4. The number of broken ties is related to the extent of the movement of the wall 124 in relation to the wall 122. In some applications, ties located transversely inward of the web restraint portions 302 can be broken, in addition to the ties located transversely outward of, and directly beneath the web restraint portions 302. For example, in some applications, the broken ties can extend transversely inward of each web restraint portions 302 by about ½-inch to about ¾-inch.

As can be seen in FIG. 4, the breaking of the ties between the perforations 50 has permitted the outer edges of the wall 122 to move outward, which in turn has caused the opening 140 to have an approximately hexagonal shape that facilitates loading larger objects into the envelope pocket 125 than otherwise would be possible. Also, as discussed above, the ability of the outer edge portions of the wall 122 to move outward as the ties between the outer perforations 50 break avoids subjecting the portions of the inter-wall seals 126 at or near the opening 140 to the excessive stress and damage that otherwise could arise if the wall 122 was fully restrained against any outward movement.

Once the opening 140 has been formed, i.e., once the sealing jaw 34 has retracted to its open position and the wall 124 has been pulled away fully from the wall 122, the controller 212 causes the actuators 326 to move the web restraint portions 302 to their respective upper positions as depicted in FIG. 5 (the flattening portions 304 have remained in their upper positions during formation of the opening 140). The controller 212 then activates the carriage actuator 312 of the trolley mechanism 308 to cause the web restraint portions 302 and the flattening portions 304 to move laterally, to their respective inward positions, in the above-discussed manner, as shown in FIG. 5. As can be seen in FIG. 5, the relatively small width, or transverse dimension, of the web restraint portions 302 permits the flattening portions 304 to assume inward positions proximate the longitudinal centerline of the web 30.

Once the web restraint portions 302 and the flattening portions 304 have reached their respective inward positions, the controller activates the flattener actuators 330 to cause the flattening portions 304 to move to their lower positions (the web restraint portions 302 remain in their upper positions throughout the remainder of the cycle).

The movement of the flattening portions 304 to their lower positions causes the lower end portion of each flattening portion 304 to enter the newly-formed opening 140 in the downstream envelope 120, and to contact the inner surface of the wall 122, i.e., the surface of the wall 122 that faces the wall 124, as shown in FIG. 6. Each flattening portion 304 contacts the upper edge portion of the wall 122, immediately above the closure-sealing element 230. (The closure-sealing element 230 is not depicted in FIGS. 4 and 5, for clarity of illustration.)

Once the flattening portions 304 have reached their lower positions, the controller activates the carriage actuator 312 of the trolley mechanism 308 to cause the web restraint portions 302 and the flattening portions 304 to move laterally outward, toward their respective outward positions. The outward movement of each flattening portion 304 while in contact with the portion of the wall 122 immediately above the closure-sealing element 230 smooths the underlying portion of the wall 122, and the closure-sealing element 230. The web restraint portions 302 and the flattening portions 304 are moved outward to positions near, but short of their respective outward positions, as depicted in FIG. 6. The web restraint portions 302 and the flattening portions 304 will remain in these transverse positions, with the web restraint portions 302 in their upper positions and the flattening portions 304 in their lower positions, until the sealing portion of the cycle is commenced.

As noted above, the transverse movement of the flattening portions 304 along the upper portion of the wall 122 smooths the upper portion of the wall 122, and the adjacent closure-sealing element 230, which in turn can enhance the strength and integrity of the closure seal subsequently formed from the closure-sealing element 230.

At this point, the downstream envelope 120 can be loaded by inserting the item to be packaged into the envelope pocket 125 by way of the fully-formed opening 140. The item can be inserted manually by the operator, or by automated equipment (not shown). As noted above, the ties associated with the perforations 50 in the center portion of the web 30 are not torn as the opening 140 is formed in the downstream envelope 120. The unbroken ties support the downstream envelope 120 from the remainder of the web 30 while the envelope 120 is loaded. For example, in some embodiments, more than 50 percent of the ties along the region of weakness can remain unbroken after the opening 140 has been formed.

The sealing portion of the cycle can commence after the envelope 120 has been loaded. The operator can commence the sealing process by providing an input to the controller 212 by way of an input device in the form of a pushbutton 336 depicted, for example, in FIG. 1. Other types of input devices, such as a foot pedal or a touchscreen, can be used in lieu of, or in addition to the pushbutton 336. Alternatively, or in addition, the sealing process can commence automatically, when the controller 212 receives an input from an optical sensor or other suitable sensing device indicating the item that to be packaged has been inserted into the envelope pocket 125.

At the start of the sealing process, the controller 212 activates the sealing jaw actuator 39 of the sealer 208 to cause the sealing jaw 34 to move inward, from its open position and toward its closed position, with the grips 222 continuing to grasp the upper edge portion of the wall 124 of the downstream envelope 120. In addition, the controller activates the carriage actuator 312 of the trolley mechanism 308 to cause the web restraint portions 302 and the flattening portions 304 to moves further outward, toward their respective outward positions.

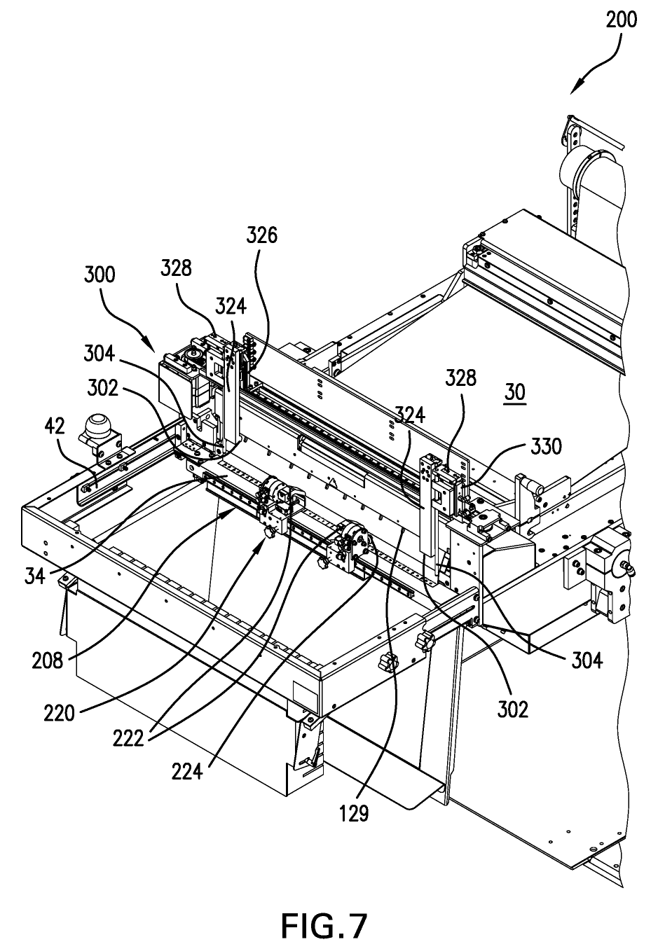

The bagging machine 200 can include a pad 332 configured to apply pressure to the envelope 120 to remove air from the envelope 120 as the wall 124 is moved toward the wall 122. The pad 332 can be moveable between an open position shown in FIG. 1, and a closed position shown in FIG. 7. The controller 212 can be configured to activate a pad actuator 334 that moves the pad 332 toward its inward position and into contact with the loaded envelope 120 as the sealing jaw 34 moves inward. Alternative embodiments of the bagging machine 200 can be configured without the pad 332.

Referring to FIG. 7, the web restraint portions 302 and the flattening portions 304 reach their respective outward positions at about the same point at which the sealing jaw 34 reaches its closed position. The flattening portions 304, which have remained in their lower positions, have moved transversely outward of the transverse edges 127 of the downstream envelope 120 after passing through the uppermost portions of the inter-wall seals 126 of the downstream envelope 120, when moving to their outward positions. As can be seen in FIGS. 6 and 7, the ability of the web restraint portions 302 and the arms 324 to move transversely with their associated flattening portions 304 has permitted each flattening portion 304 to move over, and past the portion of the upstream envelope 120 previously held in place by the web restraint portions 302.

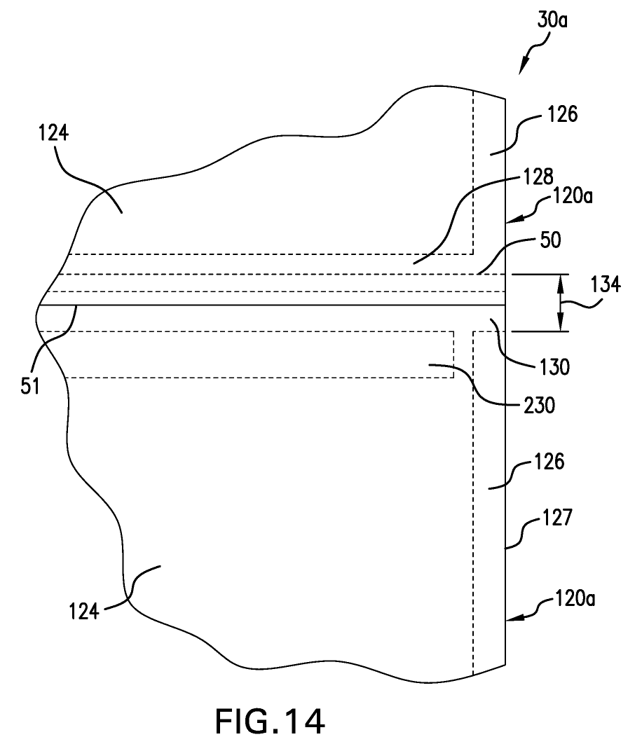

FIG. 14 depicts an alternative embodiment of the web 30 in the form of a web 30a of envelopes 120. The envelopes 120a are substantially identical to the envelopes 120, with the following except exception. The inter-wall seals 126 of the envelopes 120a are discontinuous, so as to define a gap 130 between the line of perforations 50 and the upper end of each inter-wall seal 126. The gap 130 has a longitudinal dimension, designated by the arrow 134 in FIG. 14, sufficient to permit each flattening portion 304 to move outward, beyond the transverse edge 127, without passing through the inter-wall seal 126, and below longitudinal position of the upper edge of the wall 122.

In other embodiments of the bagging machine 200, the controller 212 can be configured to cause the flattener actuators 330 to move the flattening portions 304 to their upper position immediately before the flattening portions 304 reach their associated inter-wall seals 126, so that the flattening portions 304 can travel further outward without contacting the inter-wall seals 126. In other embodiments, the sealer 208 can be configured so that the flattening portions 304 can remain between the walls 122, 124 during the sealing process, without passing over the inter-wall seals 126.

The closure-sealing element 230, and the adjacent portions of the walls 122, 124, become sandwiched between opposing surfaces of the sealing jaw 34 and the anvil 36 when the sealing jaw 34 reaches its closed position, as depicted in FIG. 10. At this point, the controller 212 causes the heating unit actuator 41 to extend the heating element 38 from the anvil 36 so that the heating bar 43 of the heating element 38 contacts the adjacent surface of the wall 122. The heating bar 43, which has been heated by the heating element 38, heats the closure-sealing element 230 by way of the wall 122. The combination of heat and pressure exerted on the closure-sealing element 230, and on the adjacent portions of the walls 122, 124 by the heating bar 43, the sealing jaw 34, and the anvil 36 activates the heat-activatable material from which the closure-sealing element 230 is formed, resulting in the formation of the closure seal. Once the heating bar 43, the sealing jaw 34, and the anvil 36 have remained in contact with the envelope 120 for a dwell time sufficient to form the closure seal, the controller 212 causes the heating unit actuator 41 to retract the heating element 38 back into the anvil 36.

As noted above, the multimodal envelope sealer 210 can select and apply sealing parameters tailored to the type of envelope 120 being sealed. The multimodal envelope sealer 210 is illustrated schematically in FIG. 18. A plurality of material configurations for the envelope 120, and respective ranges for at least two variable sealing parameters corresponding to the material configuration are stored in the memory 214 of the multimodal envelope sealer 210. The variable sealing parameters can include sealing pressure, sealing temperature, and/or dwell time.

The memory 214 is co-located on the bagging machine 200 with the controller 212. In alternative embodiments of the bagging machine 200, the memory 214 can be located remotely from the bagging machine 200 and can be communicatively coupled to the controller 212 by a suitable wireless or wired means. For example, the memory 214 can be cloud-based memory, i.e., cloud storage.

The variable sealing parameters can be, for example, two variable sealing parameters applicable under circumstances where another sealing parameter is fixed. For example, the two variable sealing parameters can be sealing temperature and dwell time, and the fixed sealing parameter can be sealing pressure. This configuration can be employed, for example, under conditions where the sealer 208 is configured to apply a single sealing pressure that does not vary between envelope types, or where the operator prefers to maintain the sealing pressure at a constant value.

The variable sealing parameters can include three or more variable sealing parameters in applications where the sealer 208 is capable of varying more than two of the sealing parameters. For example, the variable sealing parameters can include the sealing temperature, dwell time, and sealing pressure in applications where the bagging machine 200 is capable of varying each of these parameters. Also, more than one fixed sealing parameter can be used in some applications.

The ranges of the variable sealing parameter(s) can be selected so that the variable sealing parameters, in combination with the fixed sealing parameter(s), achieve a predetermined strength in the closure seal formed by the sealer 208. The predetermined strength can be, for example, a peel strength, as measured according to ASTM F88(A). As another example, the predetermined strength can be a hot tack strength, as measured according to ASTM F1921. In certain embodiments, the peel strength and/or the hot tack strength can be within the range of about 1 pound per linear inch (PLI) to about 4 PLI, about 1.5 PLI to about 2.5 PLI, about 2 PLI, etc.

In some applications, the sealing pressure can be less than or equal to about 200 psi. In other applications, the sealing pressure can be less than or equal to about 100 psi. In other applications, the sealing pressure can be less than or equal to about 75 psi. In other applications, the sealing pressure can be less than or equal to about 50 psi.

In some applications, the sealing temperature can be within a range between about 300°F to about 380°F. In other applications, the sealing temperature can be within a range between about 325°F to about 380°F. In other applications, the sealing temperature can be within a range between about 350°F and about 380°F.

In some applications, the dwell time can be within a range between about 0.25 second to about 1.5 sec. In other applications, the dwell time can be within a range between about 0.25 second to about 1 second. In other applications, the dwell time can be within the range of between about 0.25 to about 0.5 sec.

The above ranges of sealing parameters are presented for illustrative purposes only. The sealing pressure, sealing temperature, and dwell time can lie outside of these ranges in other applications.

The material configurations and the corresponding sealing parameters can be input to the memory 214 from a variety of sources. For example, the material configurations and sealing parameters can be input to the memory 214 from the input device 216 configured, for example, as a computing device.

The material configuration can include, for example, one or more of: a composition or type of the material forming the walls 122, 124 of the envelope 120; a composition or type of the closure sealing element 230; an amount of the closure sealing element 230; a configuration of the closure sealing element 230; and/or a configuration of the envelope 120.

As noted above, the types of material forming the walls 122, 124 of the envelope 120 can include, for example, paper and plastic. The type of paper can be, for example, kraft paper, extensible paper, and other types of paper. The paper can have a weight, for example, within the range of about 90 grams per square meter (gsm) to about 130 gsm. The type plastic can be, for example, polyethylene film and other types of plastic film.

The composition or type of closure sealing element 230 can include, for example, heat-activatable materials such as heat-sealable materials or hot melt adhesives. Heat-sealable materials can include, for example, emulsion-based polymers, polyolefin dispersions, water-based polymers, water-based emulsions, and thermoplastic polymers, etc.

The amount of the closure sealing element 230 can be a weight per unit area of the closure sealing element 230 within an incipient closure area at which the closure seal will be formed on the envelope 120. The amount of heat-activatable material can be within a predetermined range. For example, the amount of heat-activatable material can be within the range of about 8.14 gsm to about 11.4 gsm, e.g., about 5 lb/ream to about 7 lb/ream, where a ream is 3000 square feet.

The configuration of the closing element 230 can influence whether the closure-sealing element 230 is positioned on one, or both of the walls 122, 124 of the envelope 120.

The configuration of the envelope 120 can include, for example, whether the envelope 120 is provided as a single envelope 120 or a web 30 of envelopes 120.

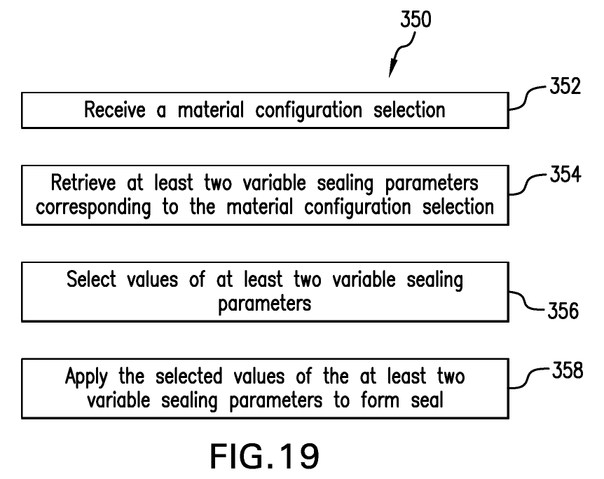

A method 350 of operating the sealer 208 is illustrated in FIG. 19. The method includes operations 352-358. In alternative embodiments, the method can include more, or fewer operations and the operations can be performed in an order different than that described herein.

In operation 352, the controller 212 receives a selection of the material configuration. The selection can be input by the user, for example, via the input device 216. The input device 216 can facilitate manual inputs, or inputs via a pre-recorded script, such as machine-readable inputs stored in a data file. The input device 216 can be a standalone device with the sole function of providing the user inputs to the controller 212, where the user inputs relate solely to the operation of the multimodal sealer 210. In alternative embodiments, the input device 216 can be an input device of the bagging machine 200, such as a touchscreen, that facilitates additional user inputs relating to the overall operation of the bagging machine 200.

In the alternative, the selected material configuration can be sensed by the sensor 215 and provided as an input to the controller 212. More specifically, the envelope 120 can include a sensible representation of the material configuration. The sensible representation can be, for example, a symbol, an alphanumeric code, a barcode, etc. The sensor 215 is configured to read the sensible representation as the envelope 112 reaches the sealer 208, and to transmit the information to the controller 212. Upon receipt, the controller 212 correlates the sensible information to a particular material configuration using, for example, a database stored in the memory 214, and the controller 212 interprets this material configuration as the selected material selection. The sensor 215 can be, for example, a camera or a bar-code reader. Other types of optical and non-optical sensors can be used as the sensor 215 in alternative embodiments.

In operation 354, the controller 212 retrieves, from the memory 214, the ranges of the variable sealing parameters corresponding to the material selection.

In operation 356, the controller 212 selects specific values for the variable sealing parameters within their respective ranges. For example, values for the variable sealing parameters can be selected in response to a user input, i.e., the respective ranges can be displayed to the user on the input device 216 so that the user can input the values of the desired sealing temperature and dwell time within their respective ranges. Alternatively, each value can be selected automatically by the controller 212, for example, as a value at the approximate midpoint of the sealing parameter range.

In further embodiments, the sealing parameter values can be interrelated. That is, the selection of one of the variable sealing parameter values within its respective range can further constrain or narrow the range, or dictate the exact value of one or both of the remaining sealing parameters. Thus, the ranges of the sealing parameter values can be represented within a boundary, or mathematical equivalent. The boundary may be defined two dimensionally when the value of one of the sealing parameters is fixed. The boundary can be three-dimensional when none of the sealing-parameter values is fixed.

In operation 358, the sealer 208 receives the selected values of the sealing parameters from the controller 212 and applies the sealing conditions in accordance with those values. In particular, the sealer 208 applies sealing pressure and heat in a closure area of the envelope 120 that includes the closure-sealing element 230, with the heat being sufficient to achieve the selected sealing temperature. The sealer 208 maintains the sealing pressure and sealing temperature for the selected dwell time. The selected values of the sealing parameters are tailored, at least in part, to the particular type of material from which envelope 120 being sealed is formed, and provide sealing conditions that produce a closure seal of sufficient strength to maintain the envelope 120 in a closed state to retain the packaged item within the envelope pocket 125.

In the alternative, the sealing parameters themselves can be represented by sensible information on the envelope 120. The sensor 215 can read the sensible information and can provide the information the controller 212 so that the controller 212 can command the sealer 208 of apply the sealing parameters, without a need for the controller 212 to retrieve the sealing parameters based on the material configuration of the envelope 120.

As noted above, the sealer 208 can operate in different sealing modes in which the values of the sealing parameters, e.g., sealing pressure, sealing temperature, and/or dwell time, are tailored to the specific material configuration of the envelope 120 being sealed. For example, a first sealing mode can be used to apply sealing conditions appropriate for paper envelopes, and a second sealing mode can be used to apply sealing conditions appropriate for plastic film. The sealing mode can be selected automatically by the controller 212 upon receiving the above noted inputs identifying the material configuration of the envelope 120 to be sealed. Upon receiving the inputs and selecting the appropriate sealing mode, the controller 212 selects the appropriate values for the sealing parameters for that particular sealing mode. The controller 212 provides inputs to the sealer 208 that cause the sealer 208 to apply the sealing parameters in accordance with the selected values thereof, to produce sealing conditions that produce a closure seal of sufficient strength to maintain the envelope 120 in the closed state.

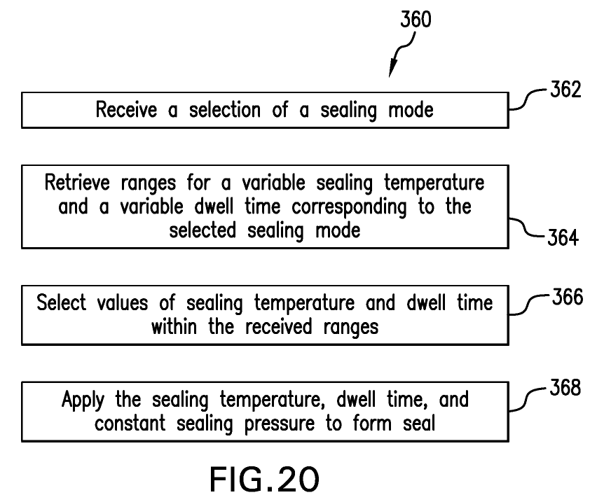

For example, FIG. 20 depicts an alternative method 360 of operating the sealer 280 in accordance with various sealing modes. The method includes operations 362-368. In alternative embodiments, the method 360 can include more, or fewer operations and the operations can be performed in an order different than that illustrated.

In accordance with the method 360, the memory 214 stores a plurality of sealing parameters corresponding to each of a plurality of sealing modes, with the sealing parameters configured to form a closure seal between first and second walls of the envelope 120. The sealing parameters include, for example, a variable sealing temperature range, a variable dwell time range, and a constant sealing pressure. The sealing modes include a first sealing mode and a second sealing mode, with the same sealing pressure used in the first and second sealing modes. The first sealing mode can be used to seal paper materials such as in the envelope 120. The second sealing mode can be used to seal plastic materials.

The method 360 reflects the ability of the sealer 280 to apply the same sealing pressure while applying different values for dwell time and sealing temperature when sealing paper and plastic. For example, the sealing temperature can be selected to achieve a target dwell time or a minimum dwell time for the fixed sealing pressure.

The constant sealing pressure can be a value suitable for paper and higher than customary for plastic, but which, in combination with the appropriate sealing temperatures and dwell times for paper and plastic, produces the required seal strength in both paper and plastic envelopes.

In operation 362, the controller 212 receives a selection of the sealing mode. The sealing mode selection can be input via the input device 216. In another example, the sealing mode selection can made by the controller 212 upon receiving an input from the sensor 215 indicating the material type as read by the sensor 215 from the sensible information on the envelope 120. The controller 212 can correlate the sensible information to the sealing mode using, for example, a predetermined database stored on the memory 214.

In operation 364, the controller 212 retrieves, from the memory 214, the plurality of sealing parameters corresponding to the selected sealing mode. As noted above, the sealing pressure is the same value for each of the first and second sealing modes.

In operation 366, the controller 212 can select the sealing temperature and dwell time within their respective ranges. For example, values for the variable sealing parameters can be selected in response to user input, i.e., the user can input the values of sealing temperature and dwell time within their respective ranges. Alternatively, the values can be selected automatically by the controller 212, for example, as a value at the approximate midpoint of the sealing parameter range.

As noted above, the sealing parameter values can be interrelated. That is, the selection of one of the at least two sealing parameter values within its respective range can further constrain (narrow) the range of one or both of the remaining sealing parameters. Thus, with the sealing pressure fixed, the ranges of the sealing temperature and dwell time can be represented within a two-dimensional boundary, or mathematical equivalent. With subsequent selection of the sealing temperature or dwell time value within its respective range, the permissible range of the other of the sealing temperature or dwell time value can be further adjusted accordingly.

In operation 368, the sealer 208 is configured to apply, in the closure area of the envelope 120 that includes the closure-sealing element 230, the sealing pressure and heat sufficient to achieve the sealing temperature. The sealer 208 is further configured to maintain the sealing pressure and sealing temperature for the selected dwell time.

The loaded and sealed downstream envelope 120 can be separated from the web 30. More specifically, the controller 212 can cause the motor 205 of the web advancement mechanism 202 to activate so as to rotate the nip rollers 204 in a direction opposite the direction needed to advance the web 30 in the downstream direction. The reverse rotation of the nip rollers 204 results in an upstream force being exerted on the web 30 upstream of the perforations 50 between the downstream envelope 120 and the adjacent envelope 120. This force, in combination with the restraint of the downstream envelope 120 by sealing jaw 34 and the anvil 36, which continue to grasp downstream envelope 120, cause the unbroken ties along the region of weakness, i.e., the line of perforations 50, to break, thereby separating the envelope 120 from the web 30.

Once the downstream envelope 132 has been separated from the web 30, the controller 212 causes the flattening element actuator 330 to move the flattening portions 304 to their upper positions. Also, the controller 212 causes the pad actuator 334 to move the pad 332 from its closed position to its open position. The controller 212 then causes the sealing jaw actuator 39 to move the sealing jaw 34 toward its open position. At this point, the grips 222 are still grasping the upper end portion of the wall 124, so that the loaded and sealed envelope 120 is moved outward along with the sealing jaw 34. As the sealing jaw 34 moves toward its open position, the controller 212 causes the actuator 223 to rotate the grips 222 upwardly, to their open position, before the sealing jaw 34 reaches its open position, releasing the loaded and sealed envelope 120.

Referring to FIG. 9, the bagging machine 200 includes a shelf 55 having a back portion 58, and a lip 60 connected to the back portion 58 proximate a lower end thereof. The upper end of the back portion 58 is coupled to an adjacent portion of the frame of the bagging machine 200 so that the back portion 58, and the attached lip 60, can rotate in relation the frame. The lip 60 supports the envelope 120 after the envelope 120 has been loaded, as shown in FIG. 9.

The bagging machine 200 also includes an actuator 56 coupled to the back portion 58 and the frame. The actuator 56 is shown in FIG. 9 in an extended position. The actuator 56 is configured to move into a retracted position (not shown) to cause back portion 58 and the lip 60 to rotate in a counterclockwise direction, from the perspective of FIG. 9. This rotation allows the loaded and sealed envelope 120 to fall off the lip 60 and drop toward a bag outlet of the bagging machine 200 as the grips 222 release the envelope 120. Once passing through the bag outlet, the envelope 120 can drop onto a conveyer, or into a bin or other holding device (not shown). Alternative embodiments of the bagging machine 200 can be configured without the shelf 55 and the actuator 56.

At this point, the bagging machine 200 can begin the next operational cycle by advancing the next envelope 120 on the web 30 in the downstream direction until the sealing area of the envelope 120 aligns with the sealing jaw 34 and the anvil 36, as shown in FIG. 1. The remainder of the next cycle then can be repeated in the above-described manner.

In some embodiments, the bagging machine 200 can have an operational mode, selectable by the operator, under which the web restraint portions 302 remain in their upper positions throughout the entire operational cycle. Such an operational mode can be used, for example, when opening and sealing envelopes formed from materials that are not prone to tearing or other damage as the envelope is opened and stretched. This feature can be combined with an additional control feature by which the sealing conditions applied to the envelopes 120 are tailored to the type of material from which the walls 122, 124 of the envelope 120 are formed, as discussed above. For example, the web restraint portions 302 may not be needed when opening an envelope formed from polyethylene, and the sealing temperature and sealing pressure needed to seal a polyethylene envelope made be lower than those needed to seal an envelope formed from paper. The bagging machine 200 may be equipped with operator-selectable operating modes that tailor the applied sealing conditions and the engagement (or non-engagement) of the web restraint portions 302 to each type of envelope.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

For example, in some alternative embodiments, the web restraint portions 302 and the flattening portions 304 can be mounted separately so that the web restraint portions 302 do not undergo any transverse movement. In such embodiments, the flattening portions 304 can be located in front of the web restraint portions 302 (or a single elongated web restraint 302 as described below), i.e., the flattening portions 304 can be located closer to the sealing jaw 34 than the web restraint portion(s) 302 when the sealing jaw 34 is in its open position. Also, the flattening portions 304 can be passive, i.e., not mechanically actuated to move vertically.

In some embodiments, the passive flattening elements can be configured so as to allow the flattening elements to rotate from their vertical orientations as the flattening elements move transversely toward their inward positions, to help minimize any drag exerted on the wall 122 of the envelope 120 by the flattening elements. Each passive flattening element can be configured with a rotational stop that prevents the flattening element from rotating past its vertical orientation as the flattening element moves transversely toward its outward position, so that the flattening element can move along the wall 122 while exerting a smoothing or flattening effect as discussed above.

In some embodiments, the passive flattening portions 304 can have a fin-type profile in which the inwardly-facing side of the flattening element is curved so as to permit the flattening element to move over the wall 122 of the envelope 120 with minimal drag. The outwardly-facing side of the flattening portion 304 can be straight, and can have a vertical orientation, to allow the flattening element to move along the wall 122 while exerting a smoothing or flattening effect as discussed above.

In some embodiments, the passive flattening elements can have a stepped configuration, an angled portion, or some other feature that permits at least the lower portion of the flattening element to pass below the breaking element(s) as the flattening element moves between its inward and outward positions.

Other alternative embodiments can be configured with flattening elements in the form of grippers that grab the opposite transverse edges 127 of the downstream envelope 120 proximate the sealing area on the envelope 120, and then retract outward, to pull the sealing area taut during the sealing process.

Other alternative embodiments can be configured without the web restraint portions 302 and their associated components, i.e., alternative embodiments can be configured without the seal-flattening capability of the bagging machine 200. In some such embodiments, the bagging machine can be equipped with the web restraint portions 302 of the bagging machine 200 and their associated actuators 326 and other components. The web restraint portions 302 can be configured to restrain the web 30 as the downstream envelope 120 is opened, as discussed above in relation to the bagging machine 200.

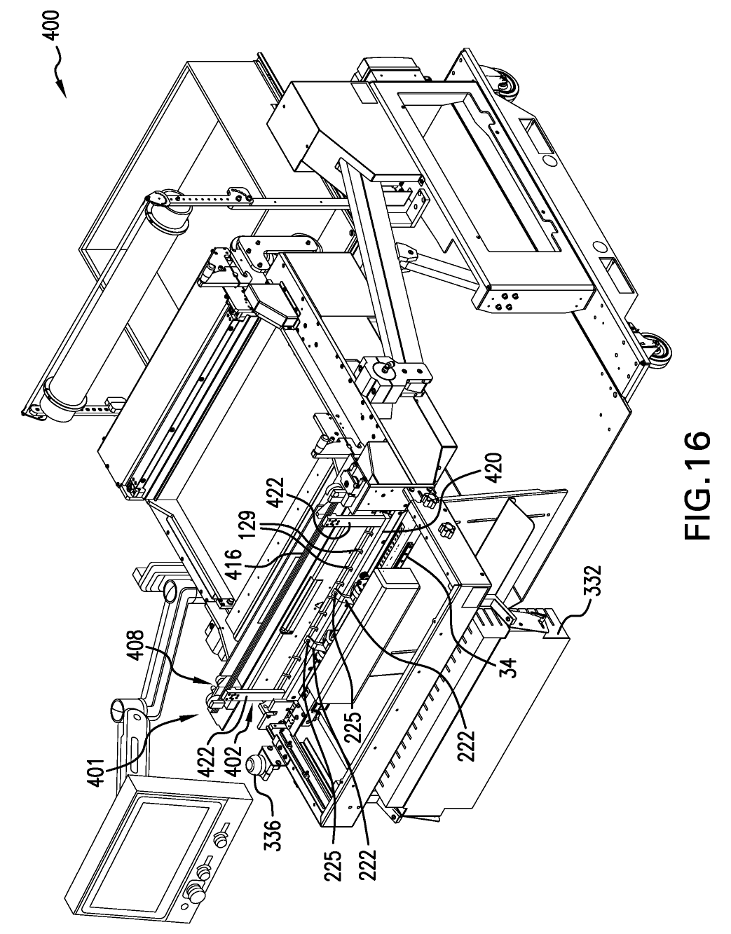

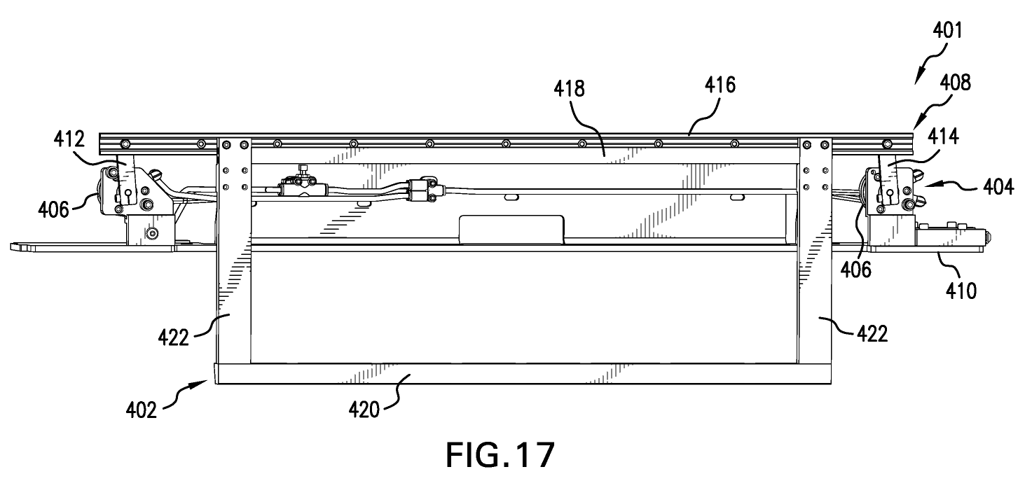

FIGS. 16-17 depict another alternative embodiment in the form of a bagging machine 400 without seal-flattening capability. The bagging machine 400 comprises a breaking element assembly 401 in lieu of the breaking element and seal flattener assembly 300 of the bagging machine 200. The bagging machine 400 otherwise is substantially similar to the bagging machine 200, and can include the multimodal sealer 210. Unless otherwise noted, the above description of the structure and operation of the bagging machine 200 (including the multimodal sealer 210) applies equally to the bagging machine 400, and common reference characters are used to denote the same, or similar components of the bagging machines 200, 400.

Referring to FIG. 17, the breaking element assembly 401 comprises a carrier assembly 402. The assembly 401 also includes an actuating mechanism 404 configured to move the carrier assembly 402 vertically, between a lower position and an upper position.

The carrier assembly 402 includes a cross-member 418; a breaking element in the form of a single, bar-shaped web restraint 420; and two arms 422. A lower end of each arm 422 is fixed to a respective end of the web restraint 420, and an upper end of each arm 422 is fixed to a respective end of the cross-member 418, so that the carrier assembly 402 has a rectangular configuration.

The actuating mechanism 404 includes two rotary actuators 406, and a three-bar linkage 408 coupled to the rotary actuators 406. Each actuator 406 is mounted on a first mounting bracket 410 of the assembly 401. The linkage 408 includes a first bar 412, a second bar 414, and a third bar 416. An end of the first bar 412 is connected to a first of the actuators 406, so that the first bar 412 is configured to be rotated by the first actuator 406. The other end of the first bar 412 is coupled to the third bar 416 proximate a first end of the third bar 416, so that the first bar 412 can rotate in relation to the third bar 416.

An end of the second bar 414 is connected to a second of the actuators 406, so that the second bar 414 is configured to be rotated by the second actuator 406. The other end of the second bar 414 is coupled to the third bar 416 proximate a second end of the third bar 416, so that the second bar 414 can rotate in relation to the third bar 416.

The third bar 416 is slidably coupled to the cross-member 418 of the carrier assembly 402 so that the rotation of the first and second bars 412, 414 causes the third bar 416 rise and lower, which in turn causes the cross-member 418 to move vertically. The vertical movement of the cross-member 418 causes the carrier assembly 402 to move between its lower and upper positions.

The above description of the actuating mechanism 404 is presented for illustrative purposes only. The carrier assembly 402 can be actuated by other devices and mechanisms in the alternative.

The breaking element assembly 401 further includes two linear guide rails (not shown). Each guide rail is mounted so that the guide rail is located adjacent to a respective one of the arms 422 of the carrier assembly 402. The guide rails restrain the carrier assembly 402 laterally, and provide a smooth bearing surface against which the arm 422 and the web restraint 420 can slide as the carrier assembly 402 translates between its lower and upper positions.

The breaking element assembly 401 also includes two cam followers (not shown). Each cam follower is mounted on a respective one of the guide rails, and includes a roller that contacts, and rides along the forward-facing surface of a corresponding one of the arms 422. The rollers help to restrain the carrier assembly 402 from movement in the forward direction, so that the web restraint 420 of the carrier assembly 402 restrains the upstream envelope 120 when the carrier assembly 402 is in its lower position.

As noted above, the web restraint 420 is configured as a single bar. The web restraint 420 has an angled contact surface (not shown). The web restraint 420 moves between an upper position (shown in FIG. 17) and a lower position (shown in FIG. 16) as the carrier assembly 401 moves between its respective upper and lower positions. The web restraint 420 does not contact the web 30 when in its upper position. The web restraint 420 contacts the web 30 when the web restraint 420 is in its lower position. More specifically, a portion of the upstream envelope 120 adjacent the perforations 50 between the upstream and downstream envelopes 120 becomes sandwiched between the contact surface of the web restraint 420 and the underlying guide bar 131 of the bagging machine 400 when the web restraint 420 is in its lower position. Due to the elongated configuration of the web restraint 420, the contact surface of the web restraint 420 contacts the upstream envelope 120 across a substantial entirety of the width of the envelope 120.

An operational sequence can begin with web restraint 420 is in its upper position, and the web advancement mechanism 202 of the bagging machine 400 advancing the web 30 in the downstream direction until the sealing area on the downstream envelope 120 is aligned with the sealing jaw 34 and the anvil 36 of the sealer 208, as discussed above in relation to the bagging machine 200.

Once the web 30 has been properly positioned, the controller 212 causes the sealing jaw 34 to move inward, to its closed position, so that the suction cups 224 of the wall handling device 220 contact the wall 124 of the downstream envelope 120. In addition, the controller 212 causes the actuating mechanism 404 to move the carrier assembly 402 from its upper to its lower position, which in turn moves the web restraint 420 to its lower position and into contact with the web 30 as discussed above.

The sealing jaw 34 subsequently is moved outward, so that the suction cups 224 pull the wall 124 away from the wall 122 so as to pre-form the opening 140 in the downstream envelope 120, as discussed above in relation to the bagging machine 200. Once the opening 140 has been pre-formed, the controller 212 causes the grips 222 of the wall handling device 220 to engage the wall 124, and the jaw 34 to move further outward, to its open position, to form the opening 140 in the downstream envelope 120.

The web restraint 420 restrains the upstream envelope 120 from movement in the outward direction, i.e., from movement toward the sealing jaw 34, as the wall 124 of the downstream envelope 120 is drawn outward by the wall handling device 220. This restraint causes the ties between the outermost perforations 50 on each side of the wall 122 to break, in the manner discussed above in relation to the bagging machine 200, which in turn permits the opening 140 in the downstream envelope 120 to assume the hexagonal shape described above.

Once the envelope 120 has been loaded via the opening 140, the sealing process can commence with the movement of the sealing jaw 34 to its closed position. As the sealing jaw 34 is moved toward its closed position, the controller 212 causes the actuating mechanism 404 to move the carrier assembly 402 from its lower to its upper position, which in turn moves the web restraint 420 to its upper position and out of contact with the web 30. The sealing process, and the separation of the sealed envelope 120 from the remainder of the web 30, subsequently proceed in the manner discussed above in relation to the bagging machine 200.

As noted above, the bagging machine 400 does not include the flattening portions 304 or other provisions to flatten or smooth the sealing area on the downstream envelope 120. In alternative embodiments, the single bar-shaped web restraint 420 can be used in conjunction with flattening elements that are shaped or otherwise configured to avoid interfering with the web restraint 420 as the flattening elements move inward and outward.

### Examples

Sealing parameters for envelopes sealing using the envelope sealer 210 were investigated for virgin kraft paper and extensible Kraft paper using a water-based heat sealable emulsion as the closure sealing element. The paper weight was about 90 to about 130 gsm (grams per square meter).

It has been discovered, unexpectedly, that the coating weight should account not only for desired strength, but also for both repulpability and recyclability. Notably, while the coating weight can allow for repulping, if the coating weight is too great, too much adhesive can be left behind and the residual adhesive can be difficult to clean.

Accordingly, multiple test coat weights for water-based, heat-sealable emulsions were evaluated. A coating weight of about 6 ± 1 lb/ream (about 8.14 gsm to about 11.4 gsm, where one ream is 3000 square feet) was found to satisfy requirements of strength, recyclability, and repulpability.

It was further identified that seal strength, as characterized by peel strength (ASTM F88(A)) and hot tack strength (ASTM F1921) should be evaluated. Notably, the strength of the seal when still hot is important when bulkier items are sealed into the envelope, as such items can create forces that cause the seal to open.

For the purpose of evaluation, a peel strength and a hot tack strength of greater than 2 PLI were established as targets. However, it can be appreciated that the target peel strength and/or hot tack strength can vary depending upon the application.

For the purpose of evaluation, 53 psi was selected as the sealing pressure. This sealing pressure is greater than that normally used to seal plastic envelopes, e.g., about 10 psi to about 15 psi, but lower than the sealing pressure normally used to seal paper envelopes, e.g., about 150 psi to about 200 psi. Sealing temperatures between 300°F and 380°F were evaluated, and dwell times between 0.25 and 0.5 seconds were evaluated. Nine measurements of peel strength were acquired for manufactured closure seals using these ranges of sealing temperatures and dwell times, with measurements taken every two inches for an 18-inch seal.

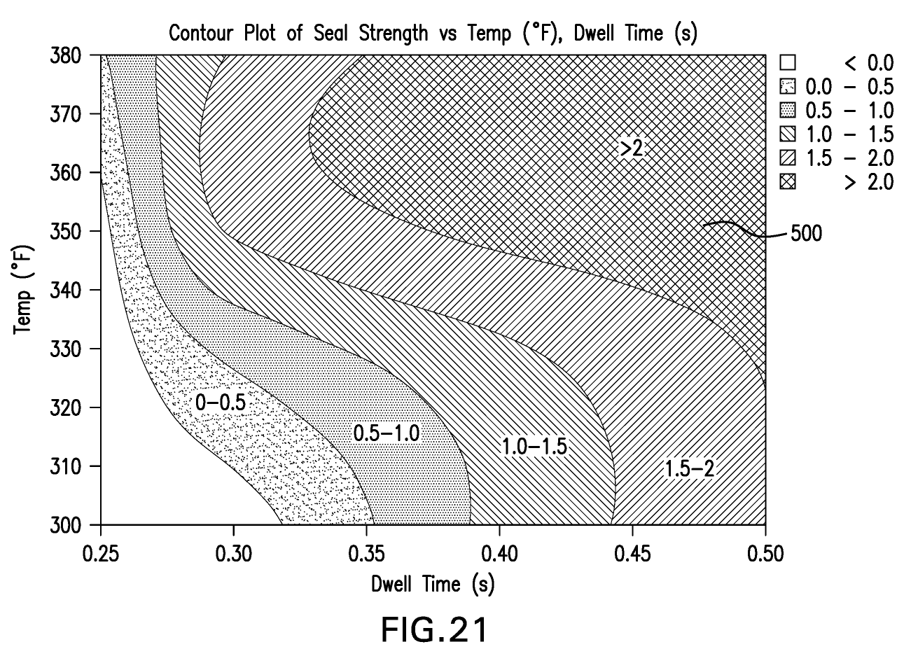

The peel strength measurements are shown in FIG. 21 as a contour plot of strength, with dwell time on the x-axis and sealing temperature on the Y-axis. The indicated peel strengths represent a confidence level of 3σ. That is to say, 99.7% of the strength measurements for a given dwell time and sealing temperature fall within the indicated range.

The contoured region representing the target peel strength of greater than 2.0 PLI is denoted in FIG. 21 by the reference number 500. It can be observed that the region 500 starts at a dwell time of about 0.5 second and a sealing temperature of about 325°F. With increasing temperature up to about 365°F, the dwell time within the region 500 decreases to a minimum of between about 0.3 second to about 0.35 second. As the temperature increases above 365°F, however, the dwell time begins to increase. These results are unexpected and significant. Notably, ranges of sealing parameters have been discovered that can achieve a peel strength in paper envelopes greater than 2 PLI, at dwell times of about 0.3 second to about 0.5 second. This range of dwell times is comparable to the dwell times typically used in sealing plastic, e.g., about 0.2 second to about 0.3 second. Furthermore, these results are achieved using a sealing pressure (53 psi) that is considerably lower than that typically used for paper (about 150 psi to about 200 psi), and closer to that used in plastic sealing (e.g., about 10 psi to about 15 psi). Additionally, the range of paper sealing temperatures, about 325°F to about 365°F, is within 150°F of that used in sealing plastic envelopes, e.g., about 260°F to about 280°F. Accordingly, it is feasible to switch between sealing plastic and paper envelopes using the multimodal envelope sealer 240 without a need to adjust the sealing pressure. Because adjusting sealing pressure in an automated bagging machine often requires making physical adjustments or modifications to the sealer, the ability to seal plastic and paper envelopes without the need for such adjustments can reduce downtime and increase the throughput of the bagging machine in applications where the bagging machine is used to seal both plastic and paper envelopes.

Certain exemplary embodiments have been described to provide an overall understanding of the principles of the structure, function, manufacture, and use of the systems, devices, and methods disclosed herein. One or more examples of these embodiments have been illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier, e.g., in a machine-readable storage device, or embodied in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and optical disks, e.g., CD and DVD disks. The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to facilitate interaction with a user. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium, i.e., modules are not software per se. Indeed “module” is to be interpreted to always include at least some physical, non-transitory hardware such as a part of a processor or computer. Two different modules can share the same physical hardware, e.g., two different modules can use the same processor and network interface. The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component, e.g., a data server, a middleware component, e.g., an application server, or a front-end component, e.g., a client computer having a graphical user interface or a web browser through which a user can interact with an implementation of the subject matter described herein, or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described embodiments. Accordingly, the present application is not to be limited by what has been particularly shown and described, except as indicated by the appended claims. All publications and references cited herein are expressly incorporated by reference in their entirety.

What is claimed is:

1. An envelope sealing machine, comprising:
a controller including a processor, the controller configured to:
obtain ranges of at least two variable sealing parameters corresponding to a material configuration of a first envelope, the at least two variable sealing parameters including a sealing pressure, a sealing temperature, and/or a dwell time over which the sealing pressure and the sealing temperature are applied to the first envelope, and
select values for each of the at least two variable sealing parameters within their respective ranges; and
a sealer communicatively coupled to the controller and including:
two opposing surfaces configured to apply the sealing pressure to a closure area on first and second walls of the first envelope, and
a heat source configured to heat the closure area to apply the sealing temperature to the closure area;
wherein the sealing pressure, the sealing temperature, and the dwell time in accordance with the selected values of the at least two variable sealing parameters produce sealing conditions sufficient to form a closure seal between the first and second walls of the first envelope in the closure area.

2. The envelope sealing machine of claim 1, wherein the sealing conditions are sufficient to form the closure seal with sufficient strength to retain an item within an envelope pocket defined by the first and second walls of the first envelope.

3. The envelope sealing machine of claim 1,
wherein the controller is configured to:
obtain ranges of at least two variable sealing parameters corresponding to a material configuration of a second envelope, the at least two variable sealing parameters corresponding to the material configuration of the second envelope including a sealing pressure, a sealing temperature, and/or a dwell time over which the sealing pressure and the sealing temperature are applied to the second envelope, and
select values for each of the at least two variable sealing parameters corresponding to the material configuration of a second envelope within their respective ranges;
wherein the opposing surfaces of the sealer are configured to apply the sealing pressure to a closure area on first and second walls of the second envelope, and the heat source is configured to heat the closure area of the second envelope to apply the sealing temperature to the closure area of the second envelope; and
wherein the sealing pressure, the sealing temperature, and the dwell time in accordance with the selected values of the at least two variable sealing parameters for the second envelope produce sealing conditions sufficient to form a closure seal between the first and second walls of the second envelope in the closure area of the second envelope.

4. The envelope sealing machine of claim 3, wherein:
the at least two variable sealing parameters corresponding to the material configurations of the first and second envelopes include the sealing temperature and the dwell time; and
the sealing pressures corresponding to the material configurations of the first and second envelopes are non-variable.

5. The envelope sealing machine of claim 4, wherein the sealing pressure corresponding to the material configuration of the first envelope is about equal to the sealing pressure corresponding to the material configuration of the second envelope.

6. The envelope sealing machine of claim 5, wherein the sealing pressure corresponding to the material configuration of the first envelope and the sealing pressure corresponding to the material configuration of the second envelope are less than or equal to about 200 psi.

7. The envelope sealing machine of claim 6, wherein the sealing pressure corresponding to the material configuration of the first envelope and the sealing pressure corresponding to the material configuration of the second envelope are between about 45 psi and about 60 psi.

8. The envelope sealing machine of claim 6, wherein:
the dwell time corresponding to the material configuration of the first envelope is within a range of about 0.3 second to about 1.5 seconds;
the sealing temperature corresponding to the material configuration of the first envelope is within a range of about 300°F to about 380°F;
the dwell time corresponding to the material configuration of the second envelope is within a range of about 0.2 second to about 0.3 second; and
the sealing temperature corresponding to the material configuration of the second envelope is within a range of about 250°F to about 290°F.

9. The envelope sealing machine of claim 1, wherein the material configuration of the first envelope includes:
a type of material forming the first envelope,
a type of heat-activatable material present on at least one of the first and second walls of the first envelope in the closure area; and/or
an amount of the heat-activatable material.

10. An envelope sealing system, comprising:
the envelope sealing machine of claim 6;
the first envelope, wherein the material type of the first envelope is paper; and
the second envelope, wherein the material type of the second envelope is plastic.

11. The envelope sealing system of claim 10, wherein:
the dwell time corresponding to the material configuration of the first envelope is within a range of about 0.3 second to about 1.5 seconds;
the sealing temperature corresponding to the material configuration of the first envelope is within a range of about 300°F to about 380°F;
the dwell time corresponding to the material configuration of the second envelope is within a range of about 0.2 second to about 0.3 second; and
the sealing temperature corresponding to the material configuration of the second envelope is within a range of about 250°F to about 290°F.

12. An envelope sealing machine, comprising:
a controller including a processor; and
a sealer communicatively coupled to the controller and including:
two opposing surfaces configured to, in response to inputs provided by the controller, apply a sealing pressure to a closure area on first and second walls of an envelope over a dwell time, and
a heat source configured to, in response to the inputs provided by the controller, heat the closure area to apply a sealing temperature to the closure area over the dwell time; wherein:
the controller is configured to select and provide as the inputs to the sealer a first set of values for the sealing pressure, sealing temperature, and dwell time corresponding to a first material configuration of the envelope,
the sealing pressure, sealing temperature, and dwell time, when applied by the sealer to the closure area of the envelope in accordance with the first set of values and with the envelope in the first material configuration, produce sealing conditions sufficient to form a closure seal between the first and second walls of the envelope in the closure area,
the controller is configured to select and provide as the inputs to the sealer a second set of values for the sealing pressure, sealing temperature, and dwell time corresponding to a second material configuration of the envelope, and
the sealing pressure, sealing temperature, and dwell time, when received by the sealer and applied by the sealer to the closure area in accordance with the second set of values and with the envelope in the second material configuration, producing sealing conditions sufficient to form the closure seal between the first and second walls of the envelope in the closure area.

13. The envelope sealing machine of claim 12, wherein the sealing conditions are sufficient to form the closure seal with sufficient strength to retain an item within an envelope pocket defined by the first and second walls of the envelope.

14. The envelope sealing machine of claim 12, wherein:
the sealer is configured to operate in a first sealing mode in which the sealer applies the sealing pressure, sealing temperature, and dwell time to the closure area of the envelope in accordance with the first set of values for the sealing pressure, sealing temperature, and dwell time; and
the sealer is configured to operate in a second sealing mode in which the sealer applies the sealing pressure, sealing temperature, and dwell time to the closure area of the envelope in accordance with the second set of values for the sealing pressure, sealing temperature, and dwell time.

15. The envelope sealing machine of claim 14, wherein:
the controller is configured to receive an input indicating the material configuration of the envelope, and to select the sealing mode of the sealer in response to the input;
the controller is communicatively coupled to a memory storing the sealing pressure, sealing temperature, and dwell time corresponding to the first and second material configurations of the envelope; and
the controller is configured to select the values of the sealing pressure, sealing temperature, and dwell time to be applied by the sealer to the closure area of the envelope by:
identifying the material configuration of the envelope based on the input indicating the material configuration of the envelope, and
retrieving, from the memory, the values of the sealing pressure, sealing temperature, and dwell time corresponding to the material configuration of the envelope.

16. The envelope sealing machine of claim 12, wherein:
the first material configuration of the envelope is paper; and
the second material configuration of the envelope is plastic.

17. The envelope sealing machine of claim 16, wherein the sealing pressure corresponding to the first material configuration of the envelope is about equal to the sealing pressure corresponding to the second material configuration of the envelope.

18. The envelope sealing machine of claim 17, wherein the sealing pressure corresponding to the first material configuration of the envelope and the sealing pressure corresponding to the second material configuration of the envelope are less than or equal to about 200 psi.

19. The envelope sealing machine of claim 18, wherein the sealing pressure corresponding to the first material configuration of the envelope and the sealing pressure corresponding to the second material configuration of the envelope are between about 45 psi and about 60 psi.

20. The envelope sealing machine of claim 18, wherein:
the dwell time corresponding to the first material configuration of the envelope is within a range of about 0.3 second to about 1.5 seconds;
the sealing temperature corresponding to the first material configuration of the envelope is within a range of about 300°F to about 380°F;
the dwell time corresponding to the second material configuration of the envelope is within a range of about 0.2 second to about 0.3 second; and
the sealing temperature corresponding to the second material configuration of the envelope is within a range of about 250°F to about 290°F.

21. A method of sealing an envelope, comprising:
receiving a first envelope having a first material configuration;
receiving a second envelope having a second material configuration;
providing an envelope sealing machine including a controller having a processor, and a sealer communicatively coupled to the controller, the sealer including:
two opposing surfaces configured to, in response to inputs provided by the controller, apply a sealing pressure to a closure area on first and second walls of the first envelope or the second envelope over a dwell time, and
a heat source configured to, in response to the inputs provided by the controller, heat the closure area on the first and second walls of the first envelope or the second envelope to apply a sealing temperature to the closure area on the first and second walls of the first envelope or the second envelope over the dwell time;
operating the sealer in a first sealing mode in which the sealer applies the sealing pressure, sealing temperature, and dwell time to the closure area of the first envelope in accordance with a first set of values for the sealing pressure, sealing temperature, and dwell time received by the sealer as the inputs from the controller, to form a closure seal between the first and second walls of the first envelope in the closure area of this first envelope; and
operating the sealer in a second sealing mode in which the sealer applies the sealing pressure, sealing temperature, and dwell time to the closure area of the second envelope in accordance with a second set of values for the sealing pressure, sealing temperature, and dwell time received by the sealer as the inputs from the controller, to form a closure seal between the first and second walls of the second envelope in the closure area of the second envelope.
